(19) United States
(12) Patent Application Publication
(10) Pub. No.: US 2026/0074741 A1
(43) Pub. Date: Mar. 12, 2026

(54) SYSTEMS AND METHODS FOR SIGNAL-TO-NOISE RATIO (SNR) MARGIN ESTIMATION FOR CABLE MODEMS

(71) Applicant: Avago Technologies International Sales Pte. Limited, Singapore (SG)

(72) Inventors: Sean Dunlap, Peachtree Corners, GA (US); Thomas Kolze, Phoenix, AZ (US); Hong Liu, Irvine, CA (US); Roger Fish, Superior, CO (US); Hau Tran, Irvine, CA (US); Kelly Cameron, Irvine, CA (US); Tak Kwan Lee, Irvine (CA); Gordon Yong Li, San Diego, CA (US)

(73) Assignee: Avago Technologies International Sales Pte. Limited, Singapore (SG)

(21) Appl. No.: 19/039,983

(22) Filed: Jan. 29, 2025

Related U.S. Application Data
(60) Provisional application No. 63/691,619, filed on Sep. 6, 2024.

(51) Int. Cl. H04B 3/46; H04L 12/28

(52) U.S. Cl. CPC H04B 3/46; H04L 12/2801

(57) ABSTRACT

In some implementations, a cable modem may include one or more processors configured to receive a target loss and a modulation configuration of the cable modem, and receive a plurality of receive modulation error ratio (RxMER) values corresponding to a plurality of subcarriers of the cable modem. The one or more processors may calculate an average loss based at least on the plurality of RxMER values and the modulation configuration. For each RxMER value corresponding to a subcarrier of the plurality of subcarriers, the one or more processors may compare the average loss with the target loss, and modify the RxMER value based on a result of the comparison. The one or more processors may set a signal-to-noise ratio (SNR) margin of the cable modem using the result of the comparison.

### CROSS-REFERENCE TO RELATED APPLICATIONS

This application claims the benefit of and priority to U.S. Provisional Patent Application No. 63/691,619 filed on Sep. 6, 2024, which is incorporated herein by reference in its entirety for all purposes.

### FIELD OF THE DISCLOSURE

This disclosure generally relates to systems and methods for improving modulation/demodulation process of a communications system, including but not limited to systems and methods of estimating SNR margins of communication links at cable modems.

### BACKGROUND

Cable operators have long held valuable the ability to estimate a signal-to-noise ratio (SNR) margin of downstream digital communications links at a cable modem (e.g., each cable modem in a plant or cable networks). The SNR margin in a cable modem refers to the difference between an actual signal strength and a minimum signal strength required to maintain a reliable connection, or any measure of the quality of the signal received by the cable modem. Specifically, cable operators have expressed the high value of the SNR Margin estimation capability developed for a cable television system defined by a standard like ITU-T J.83B. ITU-T J.83B also defines a standard for downstream cable transmission with single-carrier quadrature amplitude modulation (SC-QAM) with constellation sizes of 64-QAM and 256-QAM, and Forward Error Correction (FEC) which is a concatenated coding scheme. For example, upon installations or repairs of a cable modem (for customers), with a ITU-T J.83B-compatible SNR margin estimation tool, technicians can obtain an SNR margin estimate for the downstream link, and check if the cable modem achieves 3 dB or more of margin using the estimation tool (to check if the cable modem has been successfully installed or repaired).

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a diagram depicting an example communication environment with a plurality of cable modems and a server, according to one or more embodiments.

FIG. 2 is a schematic block diagram of a computing system, according to one or more embodiments.

FIG. 3A and FIG. 3B are diagrams depicting an example process for estimating signal-to-noise ratio (SNR) margins, according to one or more embodiments.

FIG. 4 is a diagram depicting an example communication environment with a plurality of cable modems and a server for estimating SNR margins, according to one or more embodiments.

FIG. 5A is a diagram depicting an example SNR estimator, according to one or more embodiments.

FIG. 5B is a diagram depicting an example communication environment with a cable modem and a server for monitoring SNR margins, according to one or more embodiments.

FIG. 6A to FIG. 6C are a flow diagram showing a process for estimating SNR margins, in accordance with an embodiment.

FIG. 7A and FIG. 7B are diagrams depicting example data representing a minimum average, a maximum average, and a standard deviation of RxMER samples, according to one or more embodiments.

FIG. 8 is a flow diagram showing a process for identifying SNR margins, in accordance with an embodiment.

The details of various embodiments of the methods and systems are set forth in the accompanying drawings and the description below.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, a first feature in communication with or communicatively coupled to a second feature in the description that follows may include embodiments in which the first feature is in direct communication with or directly coupled to the second feature and may also include embodiments in which additional features may intervene between the first and second features, such that the first feature is in indirect communication with or indirectly coupled to the second feature. In addition, the present disclosure may repeat reference numerals and/or letters in the various examples. This repetition is for the purpose of simplicity and clarity and does not in itself dictate a relationship between the various embodiments and/or configurations discussed.

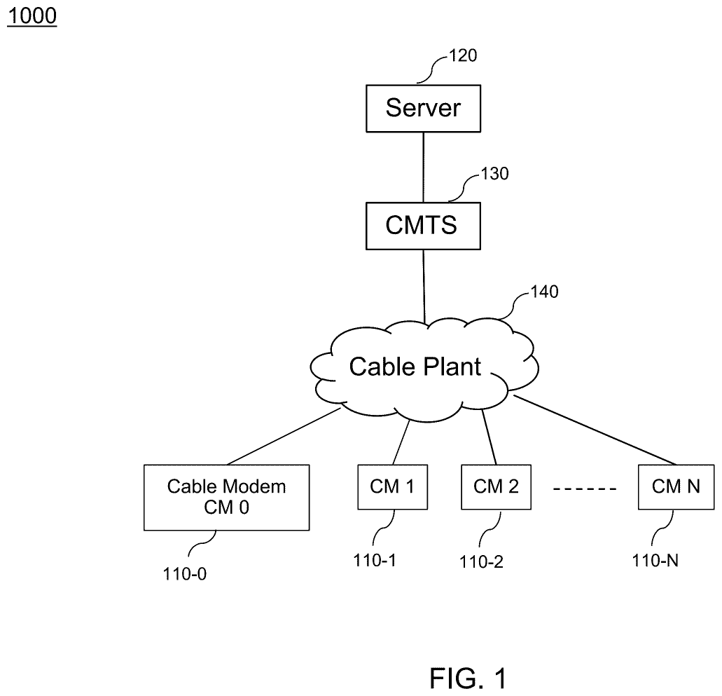

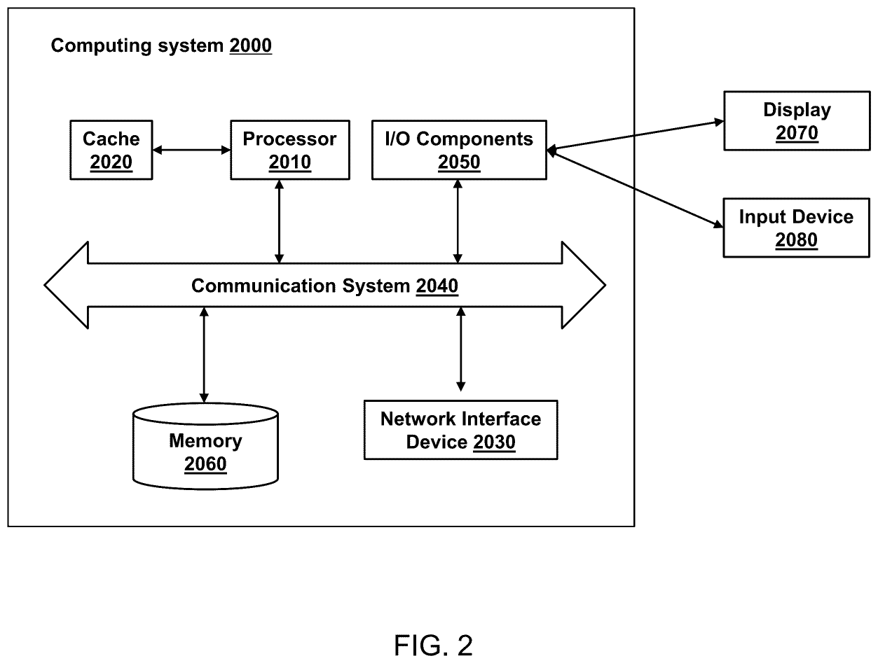

FIG. 1 is a diagram depicting an example communication environment 1000 with a plurality of cable modems 110-0, 110-1, . . . , 110-N, a server 120, a cable modem termination system (CMTS) 130, and/or a cable plant 140, according to one or more embodiments. Here, the term “cable modem” refers to a device that can function as a bridge between a local network and an internet service provider (ISP) using the same coaxial cable infrastructure that delivers cable television, a device that can convert (e.g., demodulate) data signals received from an ISP using the coaxial cable infrastructure into a format that devices in a local network (e.g., local area network (LAN)) can use, and convert (e.g., modulate) data signals from the LAN into an analog signal that can be transmitted to the ISP using the coaxial cable infrastructure, or any device that can connect a local network to the Internet using the same coaxial cable infrastructure. The term “cable modem termination system (CMTS)” refers to a system, device or equipment that is used by cable internet service providers to manage and facilitate communication between cable modems and the internet, is located in a cable company's headend or hubsite to provide data services such as cable internet or Voice over IP (VoIP) to cable subscribers, and/or enables communication with subscribers'cable modems. The term “cable plant” refers to a cable network, an HFC (hybrid fiber-Coaxial) cable network, or any physical infrastructure used for cable television and internet services. The cable plant may include all the cables, connectors, amplifiers, and other equipment used to deliver these services to customers. Each cable modem 110-0, 110-1, . . . , 110-N can include one ore more ports for the coaxial cable from an ISP, an Ethernet port to connect to a router or a computer in a local network, and/or additional ports for telephony services. Each cable modem 110-0, 110-1, . . . , 110-N can have configuration similar to configuration of a computing system 2000 in FIG. 2. The server 120 can have configuration similar to configuration of a computing system 2000 in FIG. 2. The server 120 may include a computing device (e.g., computing system 2000) and/or a cloud system. The cloud system refers to a system that can deliver one or more services over the Internet. The one or more services can include one or more services of infrastructure as a service (IaaS), platform as a service (PaaS), or software as a service (SaaS). The CMTS 130 may include a computing device (e.g., computing system 2000). The cable plant 140 may be a component in a connection between the server 120 and the cable modems 110-0, . . . 110-N. In some implementations, the cable plant may be a component in a connection between the CMTS 130 and the cable modems. In some implementations, the server 120 may include a downstream modulator for modulating downstream transmissions which the cable plant 140 conveys to the cable modems, which then perform demodulation of the downstream transmissions. In some implementations, the CMTS 130 may include a downstream modulator for modulating downstream transmissions which the cable plant 140 conveys to the cable modems, which then perform demodulation of the downstream transmissions. Each cable modem can transmit or receive data (e.g., telemetry data) to the server 120 and/or CMTS 130. For example, each cable modem can automatically collect and transmit data to the server for monitoring and analysis.

FIG. 2 is a schematic block diagram of a computing system, according to an embodiment. An illustrated example computing system 2000 includes one or more processors 2010 in direct or indirect communication, via a communication system 2040 (e.g., bus), with memory 2060, at least one network interface controller 2030 with network interface port for connection to a network (not shown), and other components, e.g., input/output (“I/O”) components 2050. Generally, the processor(s) 2010 will execute instructions (or computer programs) received from memory. The processor(s) 2010 illustrated incorporate, or are connected to, cache memory 2020. In some instances, instructions are read from memory 2060 into cache memory 2020 and executed by the processor(s) 2010 from cache memory 2020. The computing system 2000 may not necessarily contain all of these components shown in FIG. 2 and may contain other components that are not shown in FIG. 2.

In more detail, the processor(s) 2010 may be any logic circuitry that processes instructions, e.g., instructions fetched from the memory 2060 or cache 2020. In many implementations, the processor(s) 2010 are microprocessor units or special purpose processors. The computing device 2050 may be based on any processor, or set of processors, capable of operating as described herein. The processor(s) 2010 may be single core or multi-core processor(s). The processor(s) 2010 may be multiple distinct processors.

The memory 2060 may be any device suitable for storing computer readable data. The memory 2060 may be a device with fixed storage or a device for reading removable storage media. Examples include all forms of volatile memory (e.g., RAM), non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). A computing system 2000 may have any number of memory devices 2060.

The cache memory 2020 is generally a form of computer memory placed in close proximity to the processor(s) 2010 for fast read times. In some implementations, the cache memory 2020 is part of, or on the same chip as, the processor(s) 2010. In some implementations, there are multiple levels of cache 2020, e.g., L2 and L3 cache layers.

The network interface controller 2030 manages data exchanges via the network interface (sometimes referred to as network interface ports). The network interface controller 2030 handles the physical and data link layers of the OSI model for network communication. In some implementations, some of the network interface controller's tasks are handled by one or more of the processor(s) 2010. In some implementations, the network interface controller 2030 is part of a processor 2010. In some implementations, the computing system 2000 has multiple network interfaces controlled by a single controller 2030. In some implementations, the computing system 2000 has multiple network interface controllers 2030. In some implementations, each network interface is a connection point for a physical network link (e.g., a cat-5 Ethernet link). In some implementations, the network interface controller 2030 supports wireless network connections and an interface port is a wireless (e.g., radio) receiver or transmitter (e.g., for any of the IEEE 802.11 protocols, near field communication “NFC”, Bluetooth, ANT, or any other wireless protocol). In some implementations, the network interface controller 2030 implements one or more network protocols such as Ethernet. Generally, a computing device 2050 exchanges data with other computing devices via physical or wireless links through a network interface. The network interface may link directly to another device or to another device via an intermediary device, e.g., a network device such as a hub, a bridge, a switch, or a router, connecting the computing device 2000 to a data network such as the Internet.

The computing system 2000 may include, or provide interfaces for, one or more input or output (“I/O”) devices. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers.

Other components may include an I/O interface, external serial device ports, and any additional co-processors. For example, a computing system 2000 may include an interface (e.g., a universal serial bus (USB) interface) for connecting input devices, output devices, or additional memory devices (e.g., portable flash drive or external media drive). In some implementations, a computing device 2000 includes an additional device such as a co-processor, e.g., a math co-processor can assist the processor 2010 with high precision or complex calculations.

The components 2090 may be configured to connect with external media, a display 2070, an input device 2080 or any other components in the computing system 2000, or combinations thereof. The display 2070 may be a liquid crystal display (LCD), an organic light emitting diode (OLED) display, a flat panel display, a solid state display, a cathode ray tube (CRT) display, a projector, a printer or other now known or later developed display device for outputting determined information. The display 2070 may act as an interface for the user to see the functioning of the processor(s) 2010, or specifically as an interface with the software stored in the memory 2060.

The input device 2080 may be configured to allow a user to interact with any of the components of the computing system 2000. The input device 2080 may be a plurality pad, a keyboard, a cursor control device, such as a mouse, or a joystick. Also, the input device 2080 may be a remote control, touchscreen display (which may be a combination of the display 2070 and the input device 2080), or any other device operative to interact with the computing system 2000, such as any device operative to act as an interface between a user and the computing system 2000.

In one aspect, cable operators have long held valuable the ability to estimate a signal-to-noise ratio (SNR) margin of downstream digital communications links at a cable modem (e.g., each cable modem in a plant or cable networks). The SNR margin in a cable modem refers to the difference between an actual signal strength and a minimum signal strength required to maintain a reliable connection, or any measure of the quality of the signal received by the cable modem. Specifically, cable operators have expressed the high value of the SNR Margin estimation capability developed for a cable television system defined by a standard like ITU-T J.83B. ITU-T J.83B also defines a standard for downstream cable transmission with single-carrier quadrature amplitude modulation (SC-QAM) with constellation sizes of 64-QAM and 256-QAM, and Forward Error Correction (FEC) which is a concatenated coding scheme. For example, upon installations or repairs of a cable modem (for customers), with a ITU-T J.83B-compatible SNR margin estimation tool, technicians can obtain an SNR margin estimate for the downstream link, and check if the cable modem achieves 3 dB or more of margin using the estimation tool (to check if the cable modem has been successfully installed or repaired).

In one aspect, a conventional SNR margin estimation approach may operate by counting bit error corrections which occur in an outer decoder, which forms a good approximation of the bit error rate at the input to the outer decoder and thus, a good approximation of the bit error rate at the output after decoding with an inner decoder. It has been shown, and used in practice, that counting the bit error corrections in the outer decoder, when operating at lower bit error rates than FEC threshold, can be effective for accurate estimation of link margin for up to 3 dB of margin and more (for example, in additive white Gaussian noise (AWGN)). However, for the conventional SNR margin estimation tool to operate for a single carrier (SC)-QAM constellation (64-QAM or 256-QAM), the downstream link has to be operating (e.g., carrying traffic) with that constellation.

Moreover, with the roll-out of data over cable service interface specifications (DOCSIS) 3.1 and Orthogonal Frequency-Division Multiplexing (OFDM) and new FEC thereof, the conventional SNR margin estimation was no longer available with the new FEC. With DOCSIS OFDM, many variations of bit loading (and mixes of constellation size among the data carrying subcarriers) are possible. For example, with DOCSIS OFDM, cable modems support four different profiles (or bit profiles), and another profile for test purposes. Here, the “profile” (also referred to as “bit profile” or “bit loading profile”) refers to a specific configuration (e.g., number of bits that can carry traffic, modulation orders, constellation density, constellation size, etc.) for each subcarrier within an OFDM. The conventional SNR margin estimation may provide an under-estimate of the FEC threshold, which is hugely unattractive (damaging) if operated (practiced) in a cable system. The conventional SNR margin estimation will likely lead to a too aggressive bit loading profile, and eventually a failure of that profile (for example, high codeword error rate would make the profile unusable).

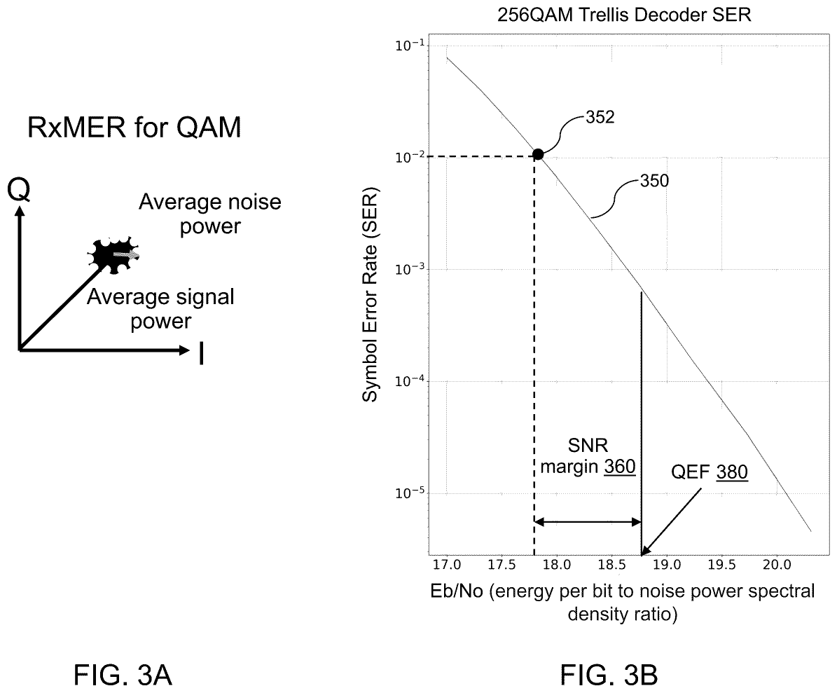

FIG. 3A and FIG. 3B are diagrams depicting an example process for estimating signal-to-noise ratio (SNR) margins, according to one or more embodiments. FIG. 3A shows a graph or plotting of signals generated within a demodulator, where a slicer (e.g., a component used to convert the received analog signal into a digital signal) has performed the function of collecting all the received signals that are approximately “closest” to one of the ideal constellation points of a quadrature amplitude modulated (QAM) signal. FIG. 3A shows the collection of signals (received over a span of many transmitted symbols) that are associated by the slicer with one constellation point. Further, the slicer function includes computing a slicer input error signal or an error value, which is the difference between (1) the received signal, which includes the effects of distortion and added noise and possibly other impairments (e.g., interference, phase noise, and so on), and (2) the ideal constellation point. In a communication environment with one or more cable modems (see FIG. 1), a channel quality (e.g., quality of signals in a channel in OFDM) can be characterized by a receive modulation error ratio (RxMER) value. RxMER refers to a ratio between average signal power of a received signal and average noise power of the signal, or a ratio between power of the received signal to power of the slicer input errors in the signal (e.g., power of the error values generated by the slicer). An RxMER value can indicate how well a signal is being received such that higher RxMER values indicate better signal quality. FIG. 3A shows calculating an RxMER value when using a quadrature amplitude modulation (QAM) which can combine two amplitude-modulated signals into one by using I/Q modulation.

FIG. 3B shows how a cable modem (e.g., a system compatible with DOCSIS 3.0) can perform an SNR margin estimation. For example, the system can use a Trellis decoder with 256 QAM. The system can measure the current symbol error rate (SER) 352 which follows a curve 350 (e.g., waterfall curve). This waterfall curve can be obtained by the inner Trellis decoder. Using the curve 350, the system can identify, as the SNR margin 360, a distance to the SER 352 from the Quasi-Error-Free (QEF) point 380 (e.g., bit error rate (BER)=1e−8 at Reed-Solomon decoder output) on the x axis (e.g., an axis representing Eb/No). The same measuring process can be applicable to a bit error rate (BER) curve. For example, the system can measure an SNR margin using the BER curve in the same manner.

DOCSIS 3.0 supports a narrow band single carrier (6 MHz per channel) and a constant QAM modulation per channel, while DOCSIS 3.1 supports a wide band channel with multiple subcarriers per channel (e.g., OFDM) and non-constant modulations across subcarriers. In performing the SNR margin estimation shown in FIG. 3B, in response to identifying or obtaining the SNR margin, the cable modem can transmit the measured SNR margin to a remote server (e.g., server 120 in FIG. 1). A similar SNR margin estimation approach is not available in DOCSIS 3.1-compliant systems for OFDM, because the inner decoder in the concatenated coding has an extremely steep slope for the error rate versus SNR and cannot provide the margin estimate reliably as in DOCSIS 3.0-compliant systems. It is advantageous for the cable modem to perform the SNR margin estimation as opposed to sending all the information back to a server each time the SNR margin estimate is desired, because significantly more modulation schemes (many different constellation densities used across the subcarriers of an OFDM channel, potentially) are used for each downstream OFDM channel, than the single carrier QAM channel in DOCSIS 3.0-compliant systems. As a result, the cable modem may need to transmit significantly more measured SNR data (RxMER per subcarrier) to the remote server, compared with the DOCSIS 3.0-compliant system. That is, if the SNR margin estimation shown in FIG. 3B is applied to a DOCSIS 3.1-compliant system, and not performed in the cable modem, significant bandwidth consumption would be incurred due to periodic RxMER polling of all devices and because the polling method of the server provides a limited control, significant overhead (e.g., increased polling rates) would be required to detect transient impairments. For example, such FEC error rate-based approach (e.g., the SNR margin estimation shown in FIG. 3B) is inaccurate with non-AWGN channel impairments. Moreover, the SNR margin estimation shown in FIG. 3B is based on measurement (e.g., measurement of SER or BER), it cannot operate on inactive profiles, e.g., profiles for one or more subcarriers that do not currently operate (do not currently carry data). In DOCSIS 3.1-compliant systems, there are multiple possible bit profiles commanded to each cable modem, and the SNR margin estimate is (in general) desired on each such profile, whether active or inactive. The SNR margin estimation approach for DOCSIS 3.0-compliant systems can only perform on the active modulation in a downstream channel.

To solve these problems, systems and methods according to some embodiments of the present disclosure can optimize OFDM in channels for cable modems by performing an SNR margin estimation. In some implementations, a system (e.g., one or more cable modems and/or a server) can perform an SNR margin estimation for inactive profiles (e.g., profiles for one or more subcarriers that do not currently operate (do not currently carry data) with DOCSIS OFDM (e.g., DOCSIS 3.1 OFDM). In some implementations, the system can use one or more SNR margin metrics (e.g., SNR margin, RxMER values, loss values, RxMER threshold) to measure OFDM profile performance of a cable modem. In some implementations, the system can reduce bandwidth by performing device side data collection and pre-processing. For example, the system collect data relating to estimated SNR margins, monitor a change of SNR margins during a predetermined time period, and transmit the data to a server in response to detecting an event. For example, the event may include, but not be limited to, a value of SNR margin goes outside of bounds, the change of SNR margins exceeds a threshold value, or the change of SNR margins falls below a threshold value. In some implementations, the system can use configurable SNR margin thresholds (e.g., a minimum SNR margin and a maximum SNR margin) and in response to the estimated SNR margin goes out of bounds (e.g., either falls below the minimum SNR margin or exceeds the maximum SNR margin), send data relating to the estimated SNR margin to the server. In this manner, the system can provide enhanced control (e.g., control of a period of transmitting data to the server).

Unlike conventional SNR margin estimation tools (e.g., SNR margin estimation shown in FIG. 3B), in some implementations, the system may not require active traffic on a profile to estimate an SNR margin. The capability of estimating SNR margin on bit profiles with no traffic or little traffic (e.g., inactive profiles) can offer a number of advantages in a cable modem system (e.g., a system with DOCSIS OFDMA). First, using the SNR margin estimation on inactive profiles, the system does not require transmitting or receiving a lot of telemetry data to or from a remote server or entity. Second, using the SNR margin estimation on inactive profiles, the system can evaluate the inactive profiles before they are switched to active. Third, using the SNR margin estimation on inactive profiles, the system does not rely on accumulating errors in a “live” (active) link, so does not require a long time to estimate margin in links with large margin. Fourth, the SNR margin estimation on inactive profiles can operate for links that would not be “working” (e.g., below an FEC threshold) if they were the active profile.

In some implementations, in performing an SNR margin estimation, a system (e.g., a cable modem system including one or more cable modems) may receive, as input data, data relating to the SNR margin estimation from a server (e.g., a cloud system). The input data may include thresholds (e.g., RxMER thresholds, SNR margin thresholds, time intervals, etc. The cable modem system may detect and send an event (e.g., an SNR margin exceeds an SNR margin threshold) to the cloud system. In some implementations, a system (e.g., one or more cable modems and/or a server) can perform an SNR margin estimation implemented for operating a downstream profile in any OFDM channel (or multiple OFDM channels), for non-operating or inactive (alternative) profiles commanded by a cable modem termination system (CMTS), and/or for other profiles not yet commanded by the CMTS. The system can (1) monitor SNR margins, (2) compare the SNR margins with thresholds, (3) log events (e.g., an SNR margin exceeds or falls below a threshold), (4) store information for subsequent reporting to the server, and/or (5) reporting the information to the server.

In some implementations, the system can solve the problem of operators not knowing SNR margins for cable modems operating in their plants (e.g., cable networks) at installation or later. The system can also provide a significant advantage of estimating the SNR margin on profiles which are not carrying traffic. This latter feature is especially important in DOCSIS 3.1 and forward, where a cable modem has a multiplicity of profiles with which the cable modem may receive traffic but at any point in time (and for long durations of time) one or most profiles may not be carrying traffic.

In some implementations, a cable modem can perform an SNR margin estimation and provide an SNR margin estimate based at least on (1) the cable modem's RxMER on each subcarrier of an OFDM channel, and/or (2) the bit loading on each data subcarrier of a profile, even inactive profiles, for a given OFDM channel. Here, the bit loading refers to a process of dynamically assigning different numbers of bits to each subcarrier based on channel conditions, or information relating to the process (e.g., the number of bits that can carry traffic in each subcarrier). The SNR margin estimation according to some implementations can perform better than the conventional SNR margin estimation tools used for SC-QAM of ITU-T J.83B (e.g., the SNR margin estimation shown in FIG. 3B) because the conventional tools are limited to evaluating the margin estimate based on the currently operating downstream modulation. The SNR margin estimation according to some implementations can operate in DOCSIS 3.1 OFDM and evaluate the SNR margin for an RxMER vector in a cable modem on any bit loading profile provided to that cable modem (by the CMTS, for example) for a particular downstream OFDM channel.

In some implementations, a system (e.g., one or more cable modems and/or a server) can have an advantage that RxMER data for a cable modem can be made available to a cloud system or other remote facility, such that the RxMER data can be subsequently used to evaluate the cable modem's SNR margin (1) with variations on the RxMER vector, (2) with any profile, or (3) with both variations on the RxMER vector and any profile. The system can evaluate the SNR margin for any profile with variations of the RxMER vector to determine an impact on the SNR margin of some degradation on some subcarriers, perhaps due to LTE interference as an example. In response to determining the impact on the SNR margin of some degradation, the system (e.g., server) can examine or perform adjustments to the bit loading of the profile to improve the SNR margin. For example, the system (e.g., server) can determine a profile that can be robust in scenarios with possible LTE interference in that cable modem.

In some implementations, a system (e.g., a cable modem or a server) can assign a loss value for each data subcarrier based at least on (1) that subcarrier's bit loading (e.g., constellation density, constellation size, the number of bits that can carry traffic) and (2) that subcarrier's RxMER value. The “loss” value or “loss” for each data subcarrier is related to the probabilities of QAM symbol error on each subcarrier, or bit errors of the QAM symbol mapping on each subcarrier, such as a symbol error rate (SER) or bit error rate (BER) for a QAM constellation at a given SNR, or any error metric for the QAM constellation at the given SNR. Here, the “loss” value or “loss” for each data subcarrier refers to a symbol error rate (SER) or bit error rate (BER) for a QAM constellation at a given SNR (or RxMER), an expected value of SER or BER for a QAM constellation at a given SNR (or RsxMER), or any error metric for the QAM constellation at the given SNR. As an example, in some FEC systems, some received bits with known low SNR may be “erased” by the FEC decoder, and the “cost” of such erasures in typical such decoders is only half as much as a bit error. The “loss” values synthesized for use in the SNR Margin Estimation invention, and in use in this invention, are developed to match the FEC coding, modulation and demodulation, and FEC decoding capabilities. In some implementations, given an RxMER (or SNR) and/or bit loading (e.g., constellation size) on each data subcarrier for a cable modem, the system can compute the average BER over the full set of data subcarriers for the cable modem. In some forward error correction coding schemes the decoder can use what is called “soft decisions,” and in other schemes the slicer can generate “hard decisions” meaning an estimate of a “1” or “0” for each received bit. In one soft decision scheme, sometimes when the slicer voltage is near a threshold, the decoder can provide an “erasure” instead of an estimate of “1” or “0.” When a decoder for such a scheme can assign an erasure, instead of making a hard decision that is wrong (i.e., a bit error from the slicer), this helps the decoder reliability. Of course, there are also instances where there is an assignment of an erasure instead of a correct decision. In many erasure decoder schemes, the erasure capability provides enhanced overall performance compared to the hard decision scheme. In such a decoder, the “loss” calculation is a little more complicated than simply computing the SER or BER. Bits that are received with very high probability of error may often be erased, and as such do not “cost” as much as a hard decision bit error for that bit decision. Empirical testing of our approach indicated that the “loss” for subcarriers with very low SNR for their constellation size was seeming less than (significantly less than) the BER probability for the subcarrier at such low SNR. This was not surprising since the LDPC decoder is known to make use of the probabilities computed from each slicer (the receiver voltage developed at the slicer, the RxMER or SNR, and the constellation size and symbol mapping), which is thus functioning as a “soft decision” decoder making use of even more “soft” information than simply an “erasure. ” In some implementations, the system can use one or more tables containing SER values and/or BER values per RxMER (or SNR) and/or per bit loading, to calculate a loss value for each data subcarrier. In some implementations, the one or more tables can be created and/or updated through testing campaigns conducted in a variety of lab conditions, combined with analysis and evaluation of the DOCSIS 3.1 LDPC FEC and various implementations of decoder. The system can identify or obtain a loss value or loss for a) a given subcarrier constellation density or constellation size, and b) RxMER value of the subcarrier, by looking up the tables with the constellation density or constellation size and RxMER value.

In some implementations, for a given bit loading profile (e.g., profile detailing the bit loading constellation density or constellation size on each data subcarrier) and a given RxMER value (or SNR value) for each data subcarrier, a system (e.g., a cable modem or a server) can compute a) the average of RxMER values (referred to as “RxMER_Average”), where the average is over all data subcarriers of one of an OFDM channel's bit loading profiles; and b) an average of loss values (referred to as “Average_Loss”), where the average is over all the subcarriers of one of an OFDM channel's bit loading profiles. For example, the Average_Loss can be an average BER or an average SER over the full channel of data subcarriers, or one of the modified “loss” values developed. In some embodiments, an Average_Loss “per bit” can be calculated by using a value of “loss” for each subcarrier, where the value of “loss” can vary from approaching zero (e.g., at very high SNR) to approaching the size (in bits) of the constellation on the subcarrier (e.g., at very low SNR). The “loss” of each data subcarrier is found based on RxMER and bit loading for each subcarrier, added over all data subcarriers, and divided by the sum of the bit loading (e.g., constellation size) of every data subcarrier. Effectively the Average_Loss “per bit” in some embodiments is the total “loss” of all data subcarriers divided by the total number of bits of all data subcarriers. The total number of bits of all data subcarriers is the constellation size of each subcarrier, totaled over all data subcarriers. The system can identify or obtain a value of target loss (referred to as “Target_Loss per bit” or “Target Loss” for short, which can be pre-determined for each cable modem. In some implementations, given a RxMER vector at a cable modem and any bit loading profile, the cable modem can perform an iterative process to determine the amount of SNR margin provided by that RxMER vector for that profile. The RxMER vector refers to a vector of respective RxMER values for a plurality of data subcarriers for a cable modem.

In some implementations, a system (e.g., one or more cable modems or a server) can constantly monitoring SNR margins in a cable modem in a cable network for a bit loading profile in use, as well as potential replacement profiles (more or less net bit rate provided). In response to SNR margin values changing a given amount (e.g., predetermined threshold value) in a duration of time (e.g., predetermined duration), or in response to an SNR margin value falling below or exceeding some threshold values, the system (e.g., cable modem) can log an event and communicate the event to the server (e.g., a cloud system) or other remote facility. If no events are logged, the cable modem can save or collect data (e.g., SNR margin values) in the cable modem, and transfer the data to the server at a convenient time for saving history. In some implementations, durations and thresholds (e.g., predetermined durations, predetermined threshold values) can be set or adjusted remotely by the server. In this manner, the system (e.g., the server) can save greatly on telemetry communications or traffic with cable modems.

In some implementations, a system (e.g., a cable modem or a server) can monitor an SNR margin estimate for any or a multiplicity (up to all to stored in the cable modem, for the cable modem-based embodiment) and monitor variations of the SNR margin estimate with time. The system can compute and/or monitor statistical values of the dynamic variation (e.g., variations of the SNR margin estimate). For example, the system can monitor minimum values of the SNR margin estimate. In some implementations, the system can monitor variations of an RxMER vector and add a variation to the (current) RxMER vector to compute a (new) RxMER threshold (referred to as “RxMER_Threshold”), such that the resulting new RxMER_Threshold can be an impaired adjustment to the current RxMER vector. In this manner, when it is known or determined or suspected that RxMER is varying rapidly, e.g., too rapidly to show up minimum excursions in RxMER in averages, the system still can set the bit loading to be adequate at the minimum excursions in RxMER by applying the adjustment to the current RxMER vector. This capability is suited to some interference scenarios, with one example being LTE interference, which is sometimes varying and typically narrowband compared to the spectrally wide OFDM channels typically used in a downstream cable.

In some implementations, the system can calculate or obtain an SNR margin estimate for inactive (or seldom) bit profiles loaded into a cable modem, thereby “knowing” or predicting if a higher-network-throughput bit loading would have a sufficient margin to use for downstream traffic. Having the accurate SNR margin estimate for inactive profiles is excellent for plant monitoring, for example, when comparing a margin for a profile in different cable modems in the plant, as well as monitoring the changes in that margin in individual cable modems.

In some implementations, the system can detect and adjust an estimated FEC threshold (also referred to as “FEC_Threshold” and also referred to as “RxMER Threshold”) in a situation where the RxMER vector has particular extreme non-flatness, or also, where there is a significant “mismatch” between the bit loading and the RxMER on a (relatively) large fraction of the data subcarriers. In some implementations, the system may estimate the FEC threshold to be a higher value than is actually the case. Estimating the FEC threshold to be higher is preferred over estimating the FEC threshold to be lower than it actually is. If the FEC threshold is actually 35.3 dB, but the estimate is 36.5 dB, then an operator may move to a different, more robust profile (lower bit loading on some or many data subcarriers) if the OFDM channel average RxMER is 35.9 dB. The operators will (likely) change to a bit loading profile with fewer total bits, more robust, and not obtain as much data throughput as with the original profile. However, the service will not experience decoder error rate higher than the goal. Because the SNR margin estimate (and the associated estimated FEC threshold) has helped the operator avoid FEC errors higher than the goal rate, this SNR margin estimate and FEC threshold estimate is “conservative,” while not ideal. On the other hand, if in the same OFDM channel and bit loading, an FEC threshold estimate of 34.5 dB is generated, an operator may let the system attempt to operate at an RxMER average of 34.9 dB, thinking (mistakenly) this is above the FEC threshold SNR. But, since it is not really, the system will encounter higher error decoder error rate than goal. This is highly undesired behavior for an SNR margin estimator. In some implementations, it is beneficial to adjust the estimated FEC threshold (perhaps by adjusting the target loss) for cases characterized by severe non-flatness of RxMER. These cases are characterized by some severe non-flatness in RxMER, or more specifically, severe non-match of RxMER compared to bit loading in a number of data subcarriers. The system can perform adjustment of the FEC threshold (or adjustment of the target loss), thereby providing more accuracy in monitoring the plant and (eventually) resulting in a higher network throughput. As an example, the SNR margin estimation according to some implementation may compute the FEC_Threshold to be 34.5 dB, but the actual FEC threshold may be 35.3 dB. In contrast, one embodiment of the SNR margin estimation may provide an FEC threshold estimate of 36.5 dB. Clearly, the FEC threshold estimate of 36.5 dB computed by the SNR margin estimation, when in reality the threshold is 35.3 dB, will not lead to FEC decoding errors at a higher rate than goal, but may lead to lower throughput due to operating with a bit loading profile with fewer overall bits. In some embodiments, even with the severely non-flat RxMER or “mismatched” RxMER and bit loading, adjustment of the FEC threshold, (such as with adjustment of the target loss), and using an SNR margin estimation and tables, operators can compute or obtain a more accurate estimate of SNR margin and FEC threshold.

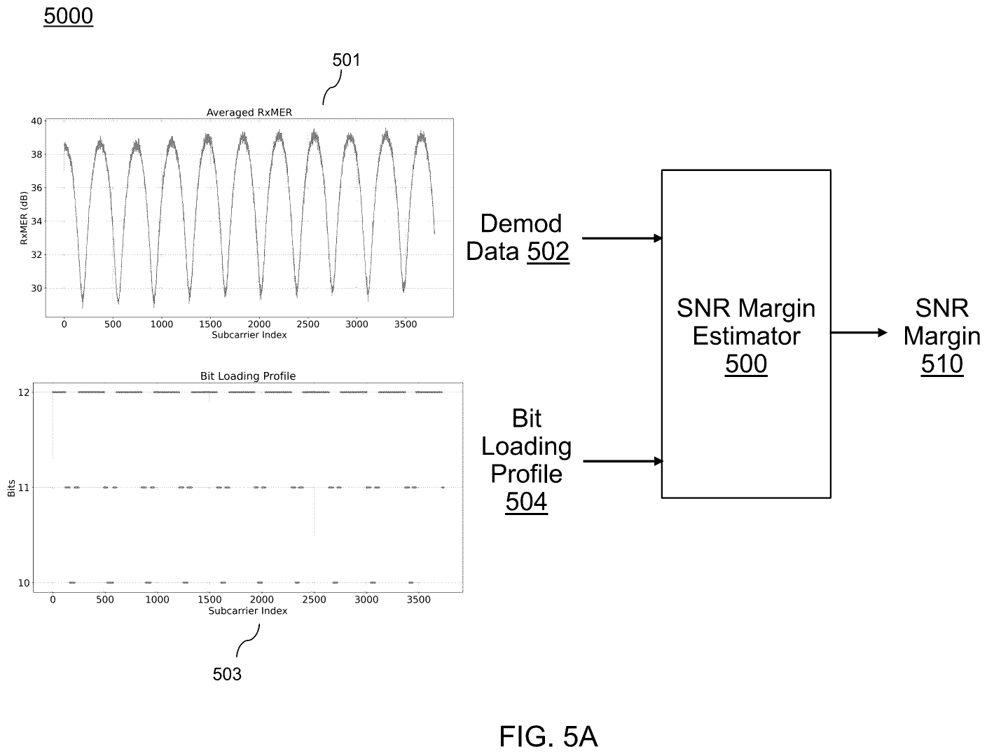

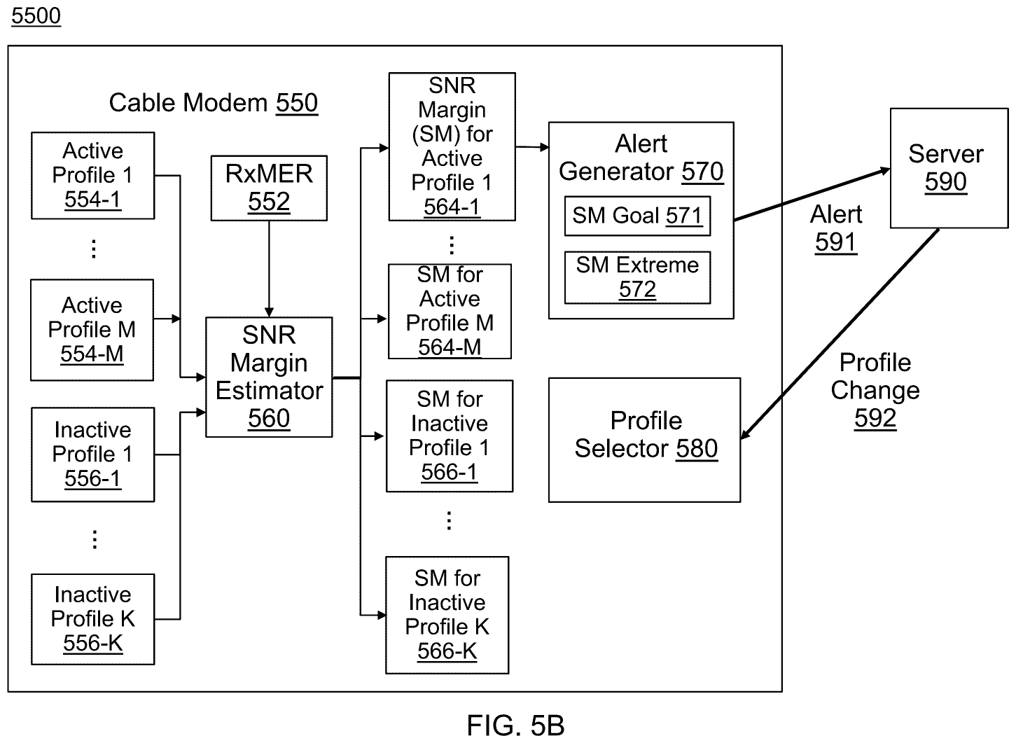

In some implementations, a communication environment may include a plurality of cable modems and a server for estimating SNR margins. Each of the plurality of cable modems and the server can have configuration similar to configuration of computing system 2000. In some implementations, a cable modem (among the plurality of cable modems) can process demodulation data (e.g., demodulation data 501 in FIG. 5). The cable modem can perform an SNR margin calculation or estimation based at least on the processed demodulation data (e.g., RxMER values). The cable modem can monitor SNR margin estimates and detect or trigger an event (e.g., an SNR margin value falls below or exceeds a threshold value, or a change of the SNR margin value lies outside the bounds). In response to detecting the event, the cable modem can send the event and/or related data (e.g., SNR margin data, RxMER data, etc.) to the server. In response to receiving the event, the server can perform an analysis of bit loading for the cable modem, and send a result of the analysis to the cable modem. The analysis result may include one or more bit loading profiles. In response to receiving the analysis result, the cable modem can perform a demodulation using the one or more bit loading profiles. In some implementations, only some cable modems (e.g., only CM 0 and CM 1 among CM 0, . . . , CM N) can proactively send data back to the server after triggering the events, thereby streamlining the bit loading profile adjustment process.

In some implementations, a system (e.g., a cable modem or a server) can include an SNR margin estimator. The SNR margin estimator can be implemented in hardware (e.g., circuitry or processor), firmware, software, or a combination thereof. The SNR margin estimator can receive, as input data, demodulation data (e.g., RxMER values) and/or a bit loading profile relating to a cable modem, and output an SNR margin value for the cable modem. For example, the SNR margin can be 1 dB, indicating that 1 dB lower in the transmitter power (on each subcarrier) would result in QEF performance. The system and method according to some implementations can calculate an SNR margin estimate as a unique metric that can accurately predict FEC performance. The system and method according to some implementations can quantify the margin of FEC performance for a given bit loading profile and/or corresponding demodulation data.

In some implementations, a system (e.g., cable modem or a server) can performs a process for estimating SNR margins in an OFDM channel as follows. At (process) step 1, the system can initialize a variable n to 0. At step 2, the system can receive RxMER values denoted by RxMER(n) on each subcarrier of a plurality of subcarriers in an OFDM channel at a cable modem. In some implementations, RxMER values may be a RxMER vector in which each element corresponds to a subcarrier of the plurality of subcarriers. In some implementations, at step 3, the system can receive bit loading information (e.g., constellation density, constellation size, or a number of bits that can carry traffic in the subcarrier) on each subcarrier based on a profile to be evaluated (e.g., a profile including bit loading information of the plurality of subcarriers). In some implementations, the bit loading on each subcarrier may not have to be currently operating (e.g., carrying traffic) in the downstream at the cable modem. In some implementations, at step 1 and step 2, the system can collect (1) RxMER and (2) subcarrier bit loading on every data subcarrier so that the system can average RxMER over time and perform other statistical manipulations such as screening for dynamic effects and/or taking minimum values over a span of time, etc. In some implementations, the system can set an increment (denoted as “RxMER_Inc”) for modifying RxMER values in an iteration process. For example, RxMER_Inc may be set to 0.1 dB.

In some implementations, at step 4, the system can obtain a loss value for each subcarrier based on corresponding RxMER value and/or bit loading information for the subcarrier. In some implementations, the system can obtain the loss value using a comprehensive loss table which shows or contains a loss value (1) for each possible data subcarrier constellation density or constellation size (0, 4, 6, 7, 8, 9, 10, 11, 12) and (2) for a fine grid of RxMER values (such as stepping 0.05 dB, just as an example). If the cable modem is capable of higher constellation density than 12 bits, then the table can extends higher.

In some implementations, at step 5, the system can obtain or identify a target loss (denoted by “Target_Loss”) based at least on configuration of the cable modem. The configuration of the cable modem may include a cable modem model type. In some implementations, the system can “learn” the target loss for cable modems operating in a plant with test profiles operating in the channel, as provided in DOCSIS specifications for OFDM, when the corresponding error statistics are made available to the server and an aggressive test profile (forcing operation of the cable modem to near the FEC threshold) is provided. In some implementations, the system can learn the target loss for cable modems using machine learning techniques or one or more look-up tables (LUT).

In some implementations, at step 6, the system can calculate an average RxMER over all subcarriers at the iteration n as RxMER_Average_Iter(n). The system can compute and save the average RxM (e.g., average the dB values of RxMER in the RxMER vector, to sum RxMER_dB over all the data subcarriers). It is noted that for n≥1, RxMER_Average_Iter(n) can equal RxMER_Average_Iter(n−1) plus RxMER_Inc (step 17) or RxMER_Average_Iter(n−1) minus RxMER_Inc (step 16) with the sign depending on the sign used in step 15.

In some implementations, at step 7, the system can calculate an average loss (denoted by Average_Loss) over all subcarriers based on the current RxMER values (denoted by RxMER(n)). The system can calculate an average of loss values of all subcarriers (which have been obtained in step 4). In some implementations, the system can calculate Average_Loss from the given (current) RxMER values for each subcarrier, e.g., the RxMER vector, combined with the bit loading of each subcarrier.

In some implementations, at step 8, the system can compare Average_Loss with the Target_Loss, for example, by computing Average_Loss minus Target_Loss. In step 9, in response to determining that Average_Loss equals Target_Loss, the system can set an RxMER threshold (denoted by RxMER_Threshold) to RxMER_Average_Iter(n). For example, at a first iteration (n=0), the RxMER threshold can be set to RxMER_Average_Iter(0), exit the iteration, calculate an SNR margin based on the RxMER threshold at step 18, and then complete the SNR margin estimation process at step 19. Similarly, at a second iteration (n=1), the RxMER threshold can be set to RxMER_Average_Iter(1), exit the iteration, calculate an SNR margin based on the RxMER threshold at step 18, and then complete the SNR margin estimation process at step 19. In response to determining that Average_Loss does not equal Target_Loss, the system can proceed to step 10.

In some implementations, at step 10, the system can determine whether the value of Average_Loss minus Target_Loss has changed its sign from previous iteration. For example, at the first iteration (n=0), the system can determine that the value of Average_Loss minus Target_Loss has not changed its sign. If n=k, the system can compare (1) the sign of Average_Loss minus Target_Loss at n=k with (2) the sign of Average_Loss minus Target_Loss at n=k−1, and determine whether the sign (1) has changed from the sign (2). In response to determining that the sign (1) has changed from the sign (2), the system can locate or bracket the RxMER_Threshold, and proceed to step 11. In response to determining that the sign (1) has not changed from the sign (2), the system can proceed to step 12.

In some implementations, at step 11, the system can determine whether Average_Loss is less than Target_Loss. In response to determining that Average_Loss is less than Target_Loss, the system can proceed to step 13 at which the system can assign RxMER_Threshold to RxMER_Average_Iter(n) which is the average RxMER at the current iteration, exit the iteration, calculate an SNR margin based on the RxMER threshold at step 18, and then complete the SNR margin estimation process at step 19. In response to determining that Average_Loss is greater than Target_Loss, the system can proceed to step 14 at which the system can assign RxMER_Threshold to RxMER_Average_Iter(n−1) which is the average RxMER at the previous iteration, exit the iteration, calculate an SNR margin based on the RxMER threshold at step 18, and then complete the SNR margin estimation process at step 19.

In some implementations, at step 12, the system can increment n by 1 and the iteration of the RxMER vector can continue, stepping each subcarrier's RxMER value up or down by RxMER_Inc, depending on whether Average_Loss is greater or less than Target_Loss. At step 15, the system can determine whether Average_Loss is less than Target_Loss. In response to determining that Average_Loss is less than Target_Loss, the system can proceed to step 16 at which the system can assign or set RxMER_Threshold to RxMER(n−1) minus RxMER_Inc, and proceed to the next iteration at step 6. In response to determining that Average_Loss is greater than Target_Loss, the system can proceed to step 17 at which the system can assign or set RxMER_Threshold to RxMER(n−1) plus RxMER_Inc, and proceed to the next iteration at step 6.

In some implementations, when the system has located or bracketed the RxMER_Threshold (e.g., steps 9, 13, 14), the system can proceed to step 618 at which the system can determine, calculate or compute an SNR margin estimate using the following equation:

SNR Margin Estimate=RxMER_Average_Iter(0)−RxMER_Threshold . . . (Equation 1)

In some implementations, when the process is completed, the system can compute RxMER_Threshold (e.g., steps 9, 13, 14, ending the iterations). The value of RxMER_Threshold can be obtained either (1) when the Average_Loss equals the Target_Loss (e.g., step 9), or (2) when the value of Average_Loss is less than Target_Loss (e.g., step 13), or (3) when the value of Average_Loss is greater than Target_Loss (e.g., step 14). In response to determining that the value of Average_Loss is less than Target_Loss (e.g., step 13), the system can decrease the RxMER vector by RxMER_Inc (e.g., step 15) to put the Average_Loss higher than Target_Loss.

In some implementations, the system can use a target symbol error rate (SER) to estimate an SNR margin. The system can modify every subcarrier's RxMER (dB) at a cable modem in lockstep, up or down, and determine the average SER across all subcarriers. The system can repeat the RxMER modification until the average SER is (approximately) equal to the target SER. After reaching the target SER, the system can calculate an average RxMER which is presumed to be the FEC threshold RxMER. Since that average RxMER achieves the target SER with that RxMER distribution, the system can determine the net adjustment in the RxMER (dB) to be the SNR margin estimate, and calculate the SNR margin estimate using the following equation:

SNR Margin Estimate=(average RxMER at the cable modem)−(estimated threshold RxMER (dB)) . . . (Equation 2)

Embodiments in the present disclosure have at least the following advantages and benefits. First, embodiments in the present disclosure can provide useful techniques for estimating SNR margin on bit profiles with no traffic or little traffic (e.g., inactive profiles). Unlike conventional SNR margin estimation tools (e.g., SNR margin estimation shown in FIG. 3B), the system may not require active traffic on a profile to estimate an SNR margin. The capability of estimating SNR margin on bit profiles with no traffic or little traffic (e.g., inactive profiles) can offer a number of advantages in a cable modem system (e.g., a system with DOCSIS OFDMA) including (1) that the system does not require transmitting or receiving a lot of telemetry data to or from a remote server or entity; (2) that the system can evaluate the inactive profiles before they are switched to active. Third, using the SNR margin estimation on inactive profiles; (3) that the system does not rely on accumulating errors in a “live” (active) link, so does not require a long time to estimate margin in links with large margin; and (4) that the SNR margin estimation on inactive profiles can operate for links that would not be “working” (e.g., below an FEC threshold) if they were the active profile.

Second, embodiments in the present disclosure can provide useful techniques for using an SNR margin estimation tool within a cable modem to monitor link health and evaluate real-time alternative profiles with higher and lower net bit rate. This capability can be used to provide event triggering in real-time (faster than collection of FEC statistics). Alternative bit loading profiles available in the cable modem (from the CMTS already) can be evaluated even though not in active use at the moment, which may be healthy as an alternative. With these features, and more, the invention still serves to reduce the necessity of sending telemetry to a remote location for the margin estimation or for event triggering. For example, a system (e.g., one or more cable modems and/or a server) can have an advantage that RxMER data for a cable modem can be made available to a cloud system or other remote facility, such that the RxMER data can be subsequently used to evaluate the cable modem's SNR margin (1) with variations on the RxMER vector, (2) with any profile, or (3) with both variations on the RxMER vector and any profile. The system can evaluate the SNR margin for any profile with variations of the RxMER vector to determine an impact on the SNR margin of some degradation on some subcarriers, perhaps due to LTE interference as an example. In response to determining the impact on the SNR margin of some degradation, the system (e.g., server) can examine or perform adjustments to the bit loading of the profile to improve the SNR margin. For example, the system (e.g., server) can determine a profile that can be robust in scenarios with possible LTE interference in that cable modem.

Third, embodiments in the present disclosure can provide useful techniques for determining a set of profiles which can be used for a group of cable modems. Embodiments involve transferring data (such as RxMER vectors) to a cloud system or remote facility, and performing evaluations of SNR margin estimation by modifying the RxMER vector based on possible or historically observed changes, such as intermittent ingress in some frequencies, and evaluating alternative bit loading profiles. If it is not feasible to have a custom bit loading profile for each cable modem, a remote facility can use the SNR margin estimation process, and the RxMER vectors and histories of each cable modem, to determine a set of profiles which can be implemented to the group and will efficiently and effectively serve the group. This is not a variation of the SNR Margin Estimation tool, but is a separate invention enabled by this particular tool, since it is operable on contemplated profiles and not limited to a currently operational profile. Because this SNR margin estimation tool or process is not limited to profiles in active use at a cable modem, this tool can be used to evaluate a multiplicity of profiles and “searches” for a profile which maximizes the net bit rate for the cable modem with its current RxMER vector.

Fourth, embodiments in the present disclosure can provide useful techniques for detecting and adjusting an estimated FEC threshold (also referred to as “FEC_Threshold Estimate” or “RxMER Threshold”) in a situation where the RxMER vector has particular extreme non-flatness. The system can determine estimate the FEC threshold to be a higher value than is actually the case. Estimating the FEC threshold to be higher is conservative. The adjustment of the FEC threshold for cases characterized by severe non-flatness of RxMER, is beneficial for achieving more accurate threshold estimates in the detected cases. These cases are characterized by some severe non-flatness in RxMER, or more specifically, severe non-match of RxMER compared to bit loading in a number of data subcarriers. The system can perform adjustment of the FEC threshold estimate (or adjust the target loss, which will adjust the FEC threshold estimate), thereby providing more accuracy in monitoring the plant and (eventually) resulting in a higher network throughput. As an example, the SNR margin estimation according to some prior art implementations can compute the FEC_Threshold Estimate to be 34.4 dB, but the actual FEC threshold may be 35.3 dB. This error in the SNR margin estimate may lead to operating the system at an SNR below the FEC threshold, and possibly incurring FEC decoding errors at a higher rate than the goal. In contrast, the SNR margin estimation in one embodiment, may provide an FEC threshold estimate of 36.5 dB. Clearly, the FEC threshold estimate of 36.5 dB computed by the conventional SNR margin estimation, when in reality the threshold is 35.3 dB, may lead to operating the system with a more robust, but lower throughput, bit loading profile, than with a more accurate SNR margin estimate for this case. However, this is preferable over operating the system below threshold, and incurring more FEC decoding errors than the goal. In some implementations, using an SNR margin estimation and tables, operators can compute or obtain an accurate estimate of SNR margin and FEC threshold.

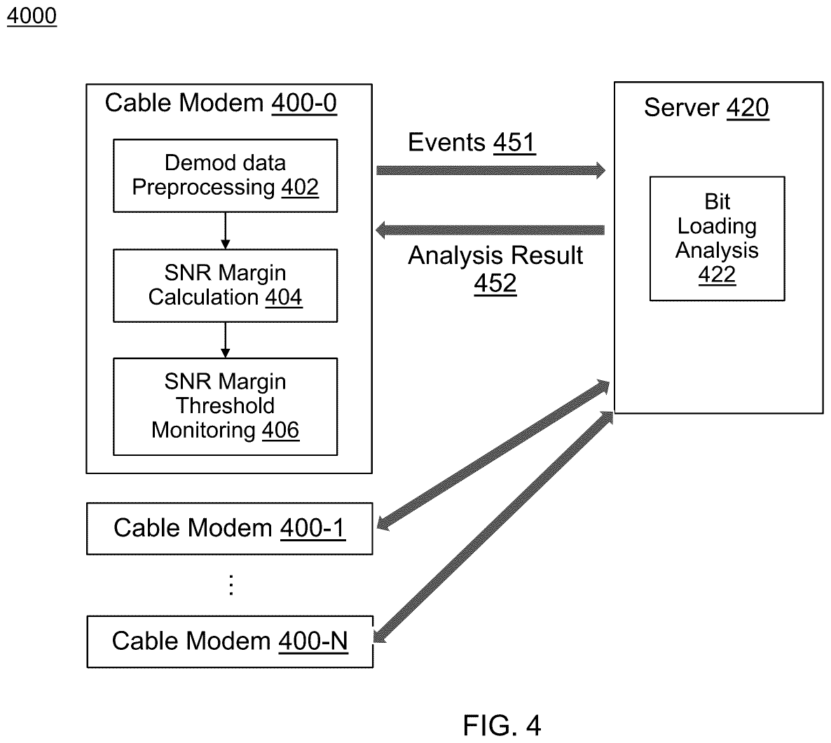

Referring to FIGS. 4-9, embodiments of systems and methods for the present solution to estimate or identify SNR margins are described and illustrated.

FIG. 4 is a diagram depicting an example communication environment 4000 with a plurality of cable modems 400-0, 400-1, . . . , 400-N and a server 420 for estimating SNR margins, according to one or more embodiments. Each of the plurality of cable modems 400-0, 400-1, . . . , 400-N and the server 420 can have configuration similar to configuration of computing system 2000. A cable modem 400-0 (among the plurality of cable modems) can process 402 demodulation data (e.g., demodulation data 501 in FIG. 5). The cable modem 400-0 can perform an SNR margin calculation or estimation 404 based at least on the processed demodulation data (e.g., RxMER values). The cable modem 400-0 can monitor 406 SNR margin estimates and detect or trigger an event 451 (e.g., an SNR margin value falls below or exceeds a threshold value, or a change of the SNR margin value lies outside the bounds). In response to detecting the event 451, the cable modem 400-0 can send the event 451 and/or related data (e.g., SNR margin data, RxMER data, etc.) to the server 420. In response to receiving the event 451, the server 420 can perform an analysis of bit loading 422 for the cable modem 400-0, and send a result of the analysis 452 to the cable modem 400-0. The analysis result may include one or more bit loading profiles. In response to receiving the analysis result, the cable modem 400-0 can perform a demodulation using the one or more bit loading profiles. In some implementations, only some cable modems (e.g., only CM 400-0 and CM 400-1 among CM 400-0, . . . , CM 400-N) can proactively send data back to the server 420 after triggering the events, thereby streamlining the bit loading profile adjustment process.

FIG. 5 is a diagram 5000 depicting an example SNR estimator 500, according to one or more embodiments. A system (e.g., a cable modem 400-0 or a server 420) can include an SNR margin estimator 500. The SNR margin estimator 500 can be implemented in hardware (e.g., circuitry or processor), firmware, software, or a combination thereof. The SNR margin estimator 500 can receive, as input data, demodulation data 502 (e.g., RxMER values per subcarrier 501) and/or a bit loading profile 504 (e.g., number of bits (or constellation density) per subcarrier 503) relating to a cable modem, and output an SNR margin value 510 for the cable modem. For example, the SNR margin can be 1 dB, indicating that 1 dB lower in the transmitter power (on each subcarrier) would result in QEF performance. The system and method according to some implementations can calculate an SNR margin estimate as a unique metric that can accurately predict FEC performance. The system and method according to some implementations can quantify the margin of FEC performance for a given bit loading profile and/or corresponding demodulation data.

FIG. 5B is a diagram depicting an example communication environment 5500 with a cable modem 550 and a server 590 for monitoring SNR margins, according to one or more embodiments.

In some implementations, a system (e.g., a cable modem and/or a server) can use the SNR margin estimate as a diagnostic, a heath metric, or set of health metrics. The system can monitor the SNR margin estimate over time, and/or monitor its extremes and its dynamic behavior, and so on. The system (e.g., server) can adjust or change a bit loading profile based on the monitored SNR margin estimate. For example, the system (e.g., server) can reduce the bit loading (e.g., constellation size) of the profile (somehow) if the SNR margin estimate is less than a threshold (e.g., a threshold indicating an SNR margin goal).

In some implementations, the system can use the SNR margin estimate in a cable modem as a health monitor for the cable modem. For example, the dynamics and variations of the RxMER and the SNR margin estimates can serve as health metrics to be monitored within the cable modem and reported as merits. The system can use the SNR margin estimate for a cable modem as a means within the system to change the bit loading profile of the downstream (e.g., CMTS or equivalent) uses for the cable modem.

It is already in the DOCSIS specification and implementations for the downstream (CMTS or equivalent) to have loaded each cable modem with several profiles, and to change the profile used for the cable modem based upon errors (e.g., FEC decoding errors) occurring on the current traffic-carrying profile. In some implementations, with FEC decoding errors occurring at too large a rate, the system can change the current (active) profile to a more robust profile, which has less throughput (e.g., lower overall number of bits in the data subcarriers of the OFDM channel).

FIG. 5B is a diagram depicting an example communication environment 5500 with a cable modem 550 and a server 590 for monitoring SNR margins, according to one or more embodiments. Each of the cable modem 550 and the server 590 can have configuration similar to configuration of computing system 2000. The cable modem can including an SNR margin estimator 560, an alert (or notification) generator 570, and/or a profile selector 580. Each of the SNR margin estimator 560, the alert generator 570, and the profile selector 580 can be implemented in hardware (e.g., circuitry or processor), firmware, software, or a combination thereof.

The SNR margin estimator 560 can receive an RxMER vector 552 including RxMER values corresponding to a plurality of data subcarriers in the cable modem 550. The SNR margin estimator 560 can receive a plurality of bit loading profiles (or “profiles”; e.g., bit loading profile 503 in FIG. 5A) 554-1, . . . , 554-M, 556-1, . . . , 556-K (each of M and K is an integer greater than or equal to 1). The plurality of profiles can include active profiles 554-1, . . . , 554-M which are currently used for demodulation by the cable modem 550, and inactive profiles 556-1, . . . , 556-K which are not currently used for demodulation by the cable modem 550. For each of the plurality of profiles 554-1, . . . , 554-M, 556-1, . . . , 556-K, the SNR margin estimator 560 can calculate or obtain the respective SNR margin or SNR margin estimate (e.g., 564-1, . . . , 564-M, 566-1, . . . , 566-K). The SNR margin estimator 560 can estimate active profiles and inactive profiles simultaneously.

The alert generator 570 can receive the SNR margin 564-m for the active profile 554-m (m is an integer greater than or equal to 1). In some implementations, the alert generator 570 can compare the SNR margin 564-m with a threshold 571 (referred to as “SNR margin goal threshold” or “SM goal threshold”). In response to determining that the SNR margin 564-m is less than the SM goal threshold 571, the alert generator 570 can generate an alert 591 (or notification) and send the alert 591 to the server 590.

In some implementations, the alert generator 570 can compare the SNR margin 564-m with a threshold 572 (referred to as “SNR margin extreme threshold” or “SM extreme threshold”). The SM extreme threshold 572 can be greater than the SM goal threshold 571. In response to determining that the SNR margin 564-m is greater than the SM extreme threshold 572, the alert generator 570 can generate an alert 591 (or notification) and send the alert 591 to the server 590.

In some implementations, the alert (or notification) 591 may include the result of the comparison (e.g., the SNR margin 564-m, the threshold 571, and/or the threshold 572) and/or the calculated SNR margins for the plurality of profiles (e.g., SNR margins 564-1, . . . , 564-m, 566-1, . . . , 566-K).

In some implementations, in response to receiving the alert 591, the server 590 can determine or select a new profile, among the plurality of profiles (e.g., profiles 556-1, . . . , 556-K), based at least on the result of the comparison and/or the calculated SNR margins for the plurality of profiles.

For example, in response to determining that the SNR margin 564-m is less than the SM goal threshold 571, the server 590 can select a new profile (e.g., 566-1) that is a more robust profile than the currently used (active) profile 554-m. The new profile may be an inactive profile. In some implementations, the new profile can incur less decoding errors than the active profile 554-m. In some implementations, the new profile can include one or more constellation sizes that are less than one or more constellation sizes of the active profile 554-m.

In response to determining that the SNR margin 564-m is greater than the SM extreme threshold 572, the server 590 can select a new profile (e.g., 566-2) that is a less robust profile than the currently used (active) profile 554-m. The new profile may be an inactive profile. In some implementations, the new profile can achieve higher throughput than the active profile 554-m. In some implementations, the new profile can include one or more constellation sizes that are greater than one or more constellation sizes of the active profile 554-m.

In some implementations, a server (e.g., a computing device or a cloud system) or a system (e.g., a system including a cable modem and a server) can invoke a change in the profile used for a cable modem to one of the more robust profiles already loaded into the cable modem (see the DOCSIS 3.1 specifications, this is “normally” what is done when the FEC decoding errors become too severe). In some implementations, the cable modem can monitor the SNR margin estimate and can proactively suggest moving to a more robust profile, before the link to the cable modem is actually incurring too many FEC decoding errors.

In some implementations, when the SNR margin estimate exceeds the SM extreme threshold, the cable modem can alert the server (or the system). In response, the server can suggest the CMTS (or equivalent) change the active profile for the downstream to the cable modem to be a higher throughput profile, among the set of profiles loaded into the cable modem (per DOCSIS 3.1 specifications).

In some implementations, with the tests (e.g., comparisons) for SNR margin estimate against the SM goal threshold and the SM extreme threshold (e.g., values can be loaded by the server to the cable modem), the system can proactively utilize the capabilities already provided within CMTSs and cable modems via the DOCSIS 3.1 specifications without requiring FEC decoding errors to actually happen.

In some implementations, the system can monitor the SNR margin on all the profiles loaded to the cable modem, not just the active profiles, but including all the inactive profiles for the cable modem and the active profiles for the cable modem. The system can calculate or obtain the SNR margin estimate for each of all the profiles loaded to the cable modem, including all the inactive profiles for the cable modem and the active profiles for the cable modem.

In some implementations, the cable modem is capable of knowing all the profiles that have an SNR margin estimate equal or exceeding the SM goal threshold. As such, the cable modem can identify and suggest to the server a (new) profile it is loaded with, which (a) has an SNR margin estimate which meets or exceeds the assigned SNR margin goal (e.g., the SM goal threshold); and/or (b) has the highest throughput. In this alternative embodiment, the cable modem can alert or notify the server of a profile it is loaded with, which satisfy the condition (a) and/or the condition (b) listed above. It is still useful to have an SM extreme threshold, for a case where the cable modem is operating with an active profile that is already the highest throughput it has been loaded with, and then if the SNR margin estimate on that highest-throughput profile rises above the SM extreme threshold, the cable modem can alert the server (or the system) of that occurrence. In this case, the server (or the system) may choose, at an appropriate time, to load the cable modem with one or more new profiles with even higher throughput, to allow taking advantage of the large SNR margin.

In some implementations, the cable modem can alert the server (or the system) of the profile with the highest throughput which also has an SNR margin estimate at or above the SM goal threshold. The server (or the system) can invoke a change in the profile used for the cable modem, making the profile with the highest throughput and an adequate SNR margin, the active profile. The cable modem may still test the SNR margin estimate against the SM goal threshold on all profiles it is loaded with. In this case, the cable modem can monitor the SNR margin estimate and proactively suggest moving to a more robust profile, before the link to the cable modem is actually incurring too many FEC decoding errors.

In some implementations, when the SNR margin estimate exceeds the SM extreme threshold for all the profiles loaded to the cable modem, or in particular the profile loaded to the cable modem which has the highest throughput, the cable modem can alert the server (or the system). The server (or the system) may choose to load one or more different profiles into the cable modem.

In some implementations, the cable modem can perform the SNR margin estimation on active profiles and inactive profiles simultaneously, and can use that information to monitor performance, provide suggestions to servers, and trigger additional debugging procedures for further diagnosis. Because any debugging signal dumping may consume resources on the cable modem side, meanwhile, if all the cable modems send debugging information to the server, it may be a huge burden and less efficient usage of network bandwidth. For intelligent monitor purpose, any channel distortion or changes that do not impact SNR margin significantly or periodically, the server might not need to take a look or of lower priority, and this SNR margin estimation tool can enable the cable modem to proactively monitor its own status, facilitate further debugging if needed, and only alert the server in serious service impaired condition, which help the server to pin-point the cable modem in trouble quickly and efficiently. Such cable modem-side intelligent monitoring can determine (1) whether an active profile X is having a sufficient SNR margin (e.g., by comparing the SNR margin with the SM goal threshold and/or the SM extreme threshold), (2) whether any inactive profile Y is having a sufficient SNR margin and higher throughput, and/or (3) whether any active (or inactive) profile experiences a dramatic change of SNR margin over time (in which case, trigger the cable modem to dump additional debugging data for further diagnosis).

In some implementations, a system (e.g., system or environment 5500) for monitoring signal-to-noise ratio (SNR) margins of one or more cable modems (e.g., cable modems 400-0, . . . , 400-N), may include a server (e.g., server 590) and a cable modem (e.g., cable modem 550) including one or more processors (e.g., processor 2010). The server may include at least one of a computing device (e.g., computing system 2000) or a cloud system. The one or more processors of the cable modem may be configured to receive a plurality of receive modulation error ratio (RxMER) values (e.g., RxMER 552) corresponding to a plurality of subcarriers of the cable modem. The one or more processors may be configured to receive a plurality of profiles (e.g., profiles 554-1, . . . , 554-M, 556-1, . . . , 556-K), each profile comprising a plurality of modulation configurations (e.g., constellation size or constellation density) corresponding to the plurality of subcarriers of the cable modem, the plurality of profiles including a first profile (e.g., active or currently used profile) with which the cable modem performs a demodulation. For each of the plurality of profiles, the one or more processors may be configured to calculate an SNR margin of the cable modem based at least on the plurality of RxMER values and the profile. The one or more processors may be configured to compare the SNR margin for the first profile (e.g., SNR margin 564-1 for active profile 554-1) with a threshold (e.g., SM goal threshold 571 or SM extreme threshold 572). The one or more processors may be configured to determine that the SNR margin for the first profile falls below or exceeds the threshold, and transmit a notification (e.g., alert 591) to the server (e.g., server 590).

In some implementations, the server may be configured to determine, based at least on the notification (e.g., alert 591), a second profile (e.g., an inactive profile among 556-1, 556-2, . . . , 556-K) among the plurality of profiles, wherein the notification comprises a result of the comparison (e.g., whether the SNR margin 564-m is less than the SM goal threshold 571, or whether the SNR margin 564-m is greater than the SM extreme threshold 572) and the plurality of SNR margins calculated for the plurality of profiles (e.g., SNR margins 564-1, . . . , 564-M, 566-1, . . . , 566-K). The server may be configured to transmit, to the cable modem, an indication of the second profile (e.g., an identifier of the second profile). In response to receiving the indication of the second profile, the cable modem may be configured to perform a demodulation using the second profile. For example, the profile selector 580 of the cable modem 550 can change the active profile (e.g., 554-1) to the second (new) profile which is an inactive profile different from the active profile.

In some implementations, the threshold may be a first threshold (e.g., SM goal threshold 571) or a second threshold (e.g., SM extreme threshold 572) greater than the first threshold. In determining the second profile, in response to determining the SNR margin for the first profile falls below the first threshold, the server may be configured to determine the second profile that incurs less decoding errors than the first profile (e.g., an inactive profile that can incur less decoding errors than the active profile). In response to determining the SNR margin for the first profile exceeds the second threshold, the server may be configured to determine the second profile that achieves higher throughput than the first profile (e.g., an inactive profile that can achieve higher throughput than the active profile).

In some implementations, each of the plurality of profiles may include a plurality of constellation sizes corresponding to the plurality of subcarriers. In determining the second profile, in response to determining the SNR margin for the first profile falls below the first threshold, the server may be configured to determine the second profile that comprises a constellation size less than a constellation size of the first profile (e.g., an inactive profile that have an average constellation size (over the plurality of subcarriers) less than an average constellation size of the active profile). In response to determining the SNR margin for the first profile exceeds the second threshold, the server may be configured to determine the second profile that comprises a constellation size greater than a constellation size of the first profile (e.g., an inactive profile that have an average constellation size (over the plurality of subcarriers) greater than an average constellation size of the active profile).

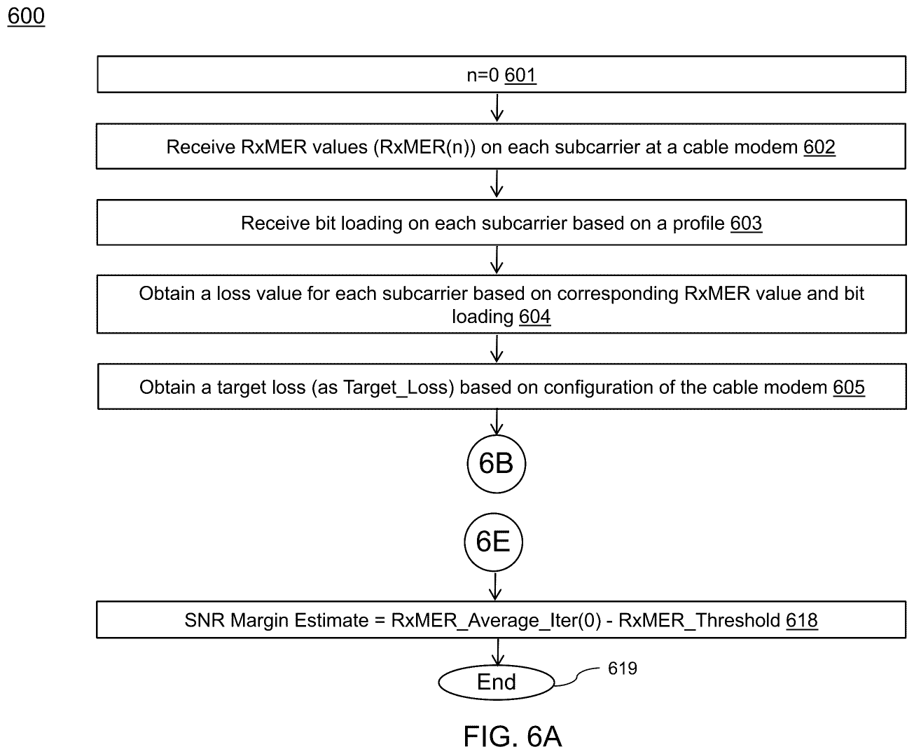

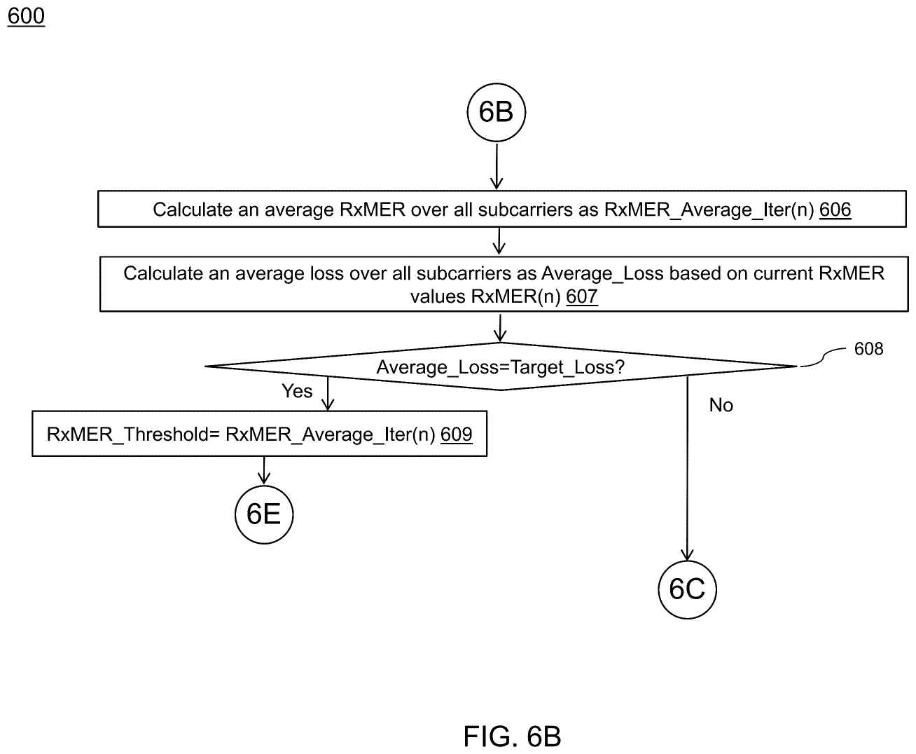

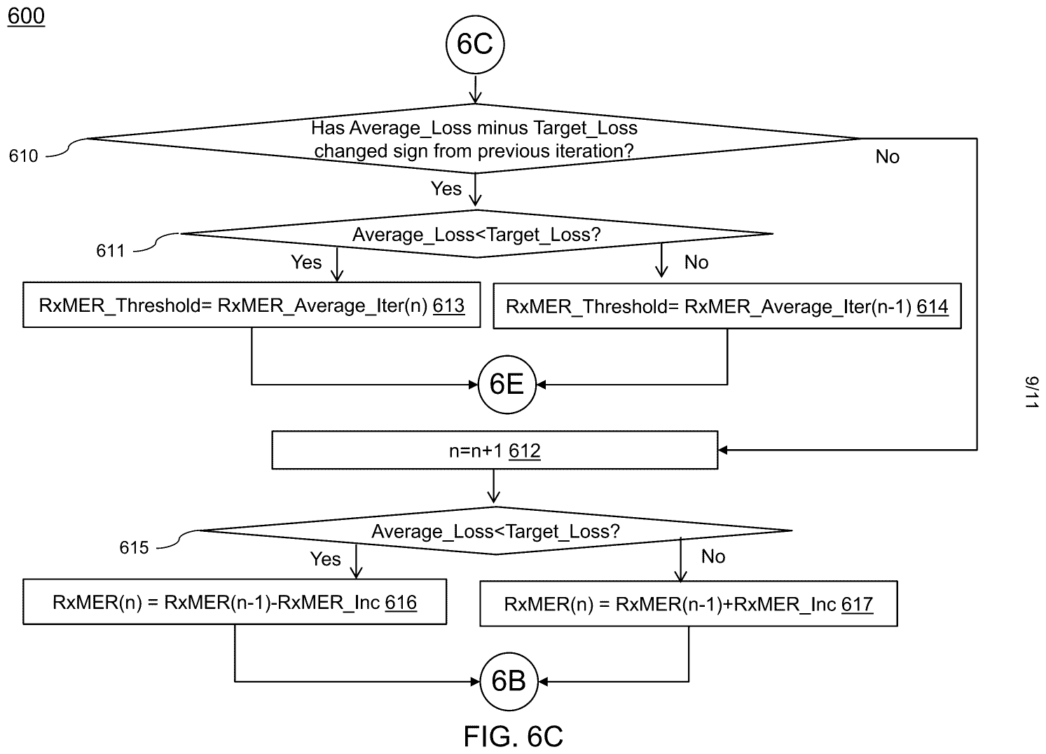

FIG. 6A to FIG. 6C are a flow diagram showing a process 600 for estimating SNR margins, in accordance with an embodiment. The process 600 is performed by one or more processors of a cable modem (e.g. processor 2010 of cable modem 400-0). In other embodiments, the process 600 is performed by other entities (e.g., a computing system other than the cable modem 400-0, for example server 420). The process 600 includes more, fewer, or different steps than shown in FIG. 6. A system (e.g., cable modem 400-0 or a server 420) can performs the process 600 for estimating SNR margins in an OFDM channel as follows. At (process) step 601, the system can initialize a variable n to 0. At step 602, the system can receive RxMER values denoted by RxMER(n) on each subcarrier of a plurality of subcarriers in an OFDM channel at a cable modem. RxMER values may be a RxMER vector in which each element corresponds to a subcarrier of the plurality of subcarriers. At step 603, the system can receive bit loading information (e.g., constellation density, constellation size, or a number of bits that can carry traffic in the subcarrier) on each subcarrier based on a profile to be evaluated (e.g., a profile including bit loading information of the plurality of subcarriers). The bit loading on each subcarrier may not have to be currently operating (e.g., carrying traffic) in the downstream at the cable modem. At step 601 and step 602, the system can collect (1) RxMER and (2) subcarrier bit loading on every data subcarrier so that the system can average RxMER over time and perform other statistical manipulations such as screening for dynamic effects and/or taking minimum values over a span of time, etc. The system can set an increment (denoted as “RxMER_Inc”) for modifying RxMER values in an iteration process. For example, RxMER_Inc may be set to 0.1 dB.

At step 604, the system can obtain a loss value for each subcarrier based on corresponding RxMER value and/or bit loading information for the subcarrier. The system can obtain the loss value using a comprehensive loss table which shows or contains a loss value (1) for each possible data subcarrier constellation density or constellation size (0, 4, 6, 7, 8, 9, 10, 11, 12) and (2) for a fine grid of RxMER values (such as stepping 0.05 dB, just as an example). If the cable modem is capable of higher constellation density than 12 bits, then the table can extends higher.

At step 605, the system can obtain or identify a target loss (denoted by “Target_Loss”) based at least on configuration of the cable modem. The configuration of the cable modem may include a cable modem model type. The system can “learn” the target loss for cable modems operating in a plant with test profiles operating in the channel, as provided in DOCSIS specifications for OFDM, when the corresponding error statistics are made available to the server and an aggressive test profile (forcing operation of the cable modem to near the FEC threshold) is provided. The system can learn the target loss for cable modems using machine learning techniques or one or more look-up tables (LUT).

At step 606, the system can calculate an average RxMER over all subcarriers at the iteration n as RxMER_Average_Iter(n). The system can compute and save the average RxM (e.g., average the dB values of RxMER in the RxMER vector, to sum RxMER_dB over all the data subcarriers). It is noted that for n≥1, RxMER_Average_Iter(n) can equal RxMER_Average_Iter(n−1) plus RxMER_Inc (step 617) or RxMER_Average_Iter(n−1) minus RxMER_Inc (step 616) with the sign depending on the sign used in step 615.

At step 607, the system can calculate an average loss (denoted by Average_Loss) over all subcarriers based on the current RxMER values (denoted by RxMER(n)). The system can calculate an average of loss values of all subcarriers (which have been obtained in step 604). The system can calculate Average_Loss from the given (current) RxMER values for each subcarrier, e.g., the RxMER vector, combined with the bit loading of each subcarrier.

At step 608, the system can compare Average_Loss with the Target_Loss, for example, by computing Average_Loss minus Target_Loss. In step 609, in response to determining that Average_Loss equals Target_Loss, the system can set an RxMER threshold (denoted by RxMER_Threshold) to RxMER_Average_Iter(n). For example, at a first iteration (n=0), the RxMER threshold can be set to RxMER_Average_Iter(0), exit the iteration, calculate an SNR margin based on the RxMER threshold at step 618, and then complete the SNR margin estimation process at step 619. Similarly, at a second iteration (n=1), the RxMER threshold can be set to RxMER_Average_Iter(1), exit the iteration, calculate an SNR margin based on the RxMER threshold at step 618, and then complete the SNR margin estimation process at step 619. In response to determining that Average_Loss does not equal Target_Loss, the system can proceed to step 610.

At step 610, the system can determine whether the value of Average_Loss minus Target_Loss has changed its sign from previous iteration. For example, at the first iteration (n=0), the system can determine that the value of Average_Loss minus Target_Loss has not changed its sign. If n=k, the system can compare (1) the sign of Average_Loss minus Target_Loss at n=k with (2) the sign of Average_Loss minus Target_Loss at n=k−1, and determine whether the sign (1) has changed from the sign (2). In response to determining that the sign (1) has changed from the sign (2), the system can locate or bracket the RxMER_Threshold, and proceed to step 611. In response to determining that the sign (1) has not changed from the sign (2), the system can proceed to step 612.

At step 611, the system can determine whether Average_Loss is less than Target_Loss. In response to determining that Average_Loss is less than Target_Loss, the system can proceed to step 613 at which the system can assign RxMER_Threshold to RxMER_Average_Iter(n) which is the average RxMER at the current iteration, exit the iteration, calculate an SNR margin based on the RxMER threshold at step 618, and then complete the SNR margin estimation process at step 619. In response to determining that Average_Loss is greater than Target_Loss, the system can proceed to step 614 at which the system can assign RxMER_Threshold to RxMER_Average_Iter(n−1) which is the average RxMER at the previous iteration, exit the iteration, calculate an SNR margin based on the RxMER threshold at step 618, and then complete the SNR margin estimation process at step 619.

At step 612, the system can increment n by 1 and the iteration of the RxMER vector can continue, stepping each subcarrier's RxMER value up or down by RxMER_Inc, depending on whether Average_Loss is greater or less than Target_Loss. At step 615, the system can determine whether Average_Loss is less than Target_Loss. In response to determining that Average_Loss is less than Target_Loss, the system can proceed to step 616 at which the system can assign or set RxMER_Threshold to RxMER(n−1) minus RxMER_Inc, and proceed to the next iteration at step 606. In response to determining that Average_Loss is greater than Target_Loss, the system can proceed to step 617 at which the system can assign or set RxMER_Threshold to RxMER(n−1) plus RxMER_Inc, and proceed to the next iteration at step 606.

When the system has located or bracketed the RxMER_Threshold (e.g., steps 609, 613, 614), the system can proceed to step 618 at which the system can determine, calculate or compute an SNR margin estimate using Equation 1.

When the process is completed, the system can compute RxMER_Threshold (e.g., steps 609, 613, 614, ending the iterations). The value of RxMER_Threshold can be obtained either (1) when the Average_Loss equals the Target_Loss (e.g., step 609), or (2) when the value of Average_Loss is less than Target_Loss (e.g., step 613), or (3) when the value of Average_Loss is greater than Target_Loss (e.g., step 614). In response to determining that the value of Average_Loss is less than Target_Loss (e.g., step 613), the system can decrease the RxMER vector by RxMER_Inc (e.g., step 615) to put the Average_Loss higher than Target_Loss.

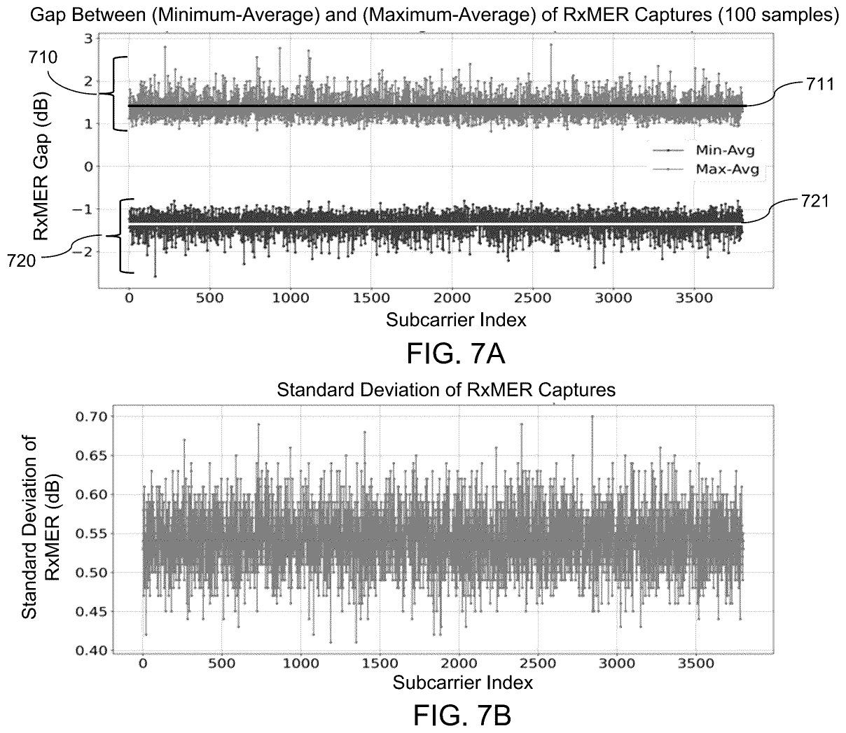

FIG. 7A shows example data representing minimum values minus an average value 710, maximum values minus an average value 720, an average 711 of the minimum values minus the average value, an average 721 of the maximum values minus the average value of 100 RxMER samples. FIG. 7B shows example data representing a standard deviation of 100 RxMER samples. FIG. 7A and FIG. 7B show a use case for pre-processed data collections (e.g., RxMER samples). In some implementations, a system (e.g., a cable modem and/or a sever) can use the minimum values minus average value 710, maximum values minus average value 720, an average 711 of the minimum values minus average value, an average 721 of the maximum values minus average value of 100 RxMER samples, for anomaly detection.

For example, for AWGN noise, the minimum RxMER values and maximum RxMER values are symmetric around the average RxMER for a given subcarrier. The system can determine whether the minimum RxMER values are symmetric around the average (minimum) RxMER, or whether the maximum RxMER values are symmetric around the average (maximum) RxMER. In response to determining that the minimum RxMER values are non-symmetric around the average (minimum) RxMER (or that the maximum RxMER values are non-symmetric around the average (maximum) RxMER), the system can determine that the RxMER values have inconsistent behavior due to (possibly) additional noise source. It is observed that transient ingress noise can impact the minimum and/or maximum of RxMER more than the average RxMER. The system can perform anomaly detection based on these observations across different subcarriers. In some implementations, in response to determining regions (e.g., subcarriers or channel) which show anomalous behaviors, the system can use additional SNR margin or the minimum RxMER value to improve performance (e.g., performance of profile management applications).

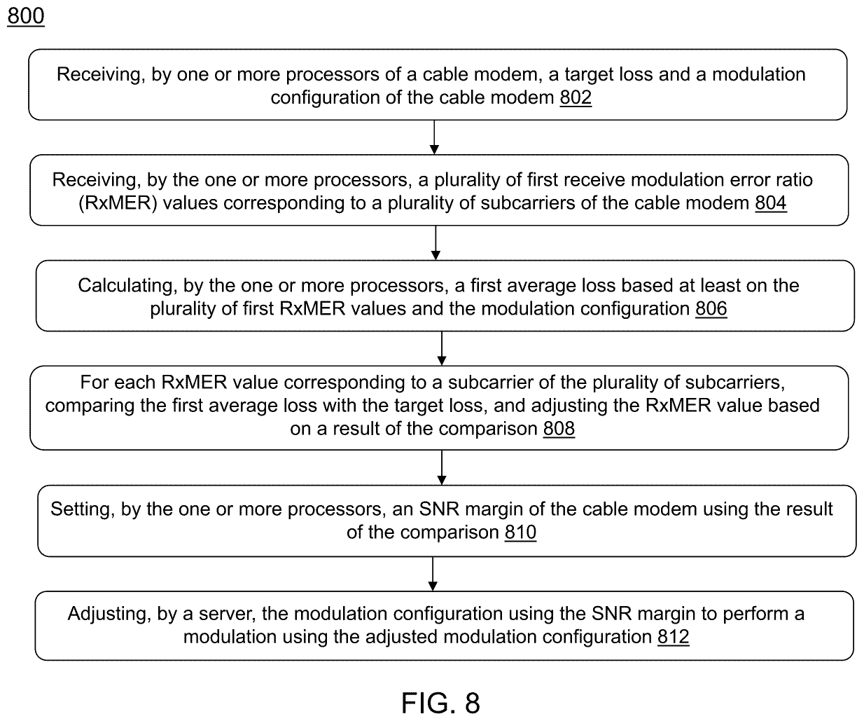

FIG. 8 is a flow diagram showing a process 800 for identifying SNR margins, in accordance with an embodiment. In some implementations, the process 800 is performed by one or more processors of a cable modem (e.g. processor 2010 of cable modem 400-0). In other embodiments, the process 800 is performed by other entities (e.g., a computing system other than the cable modem 400-0). In some implementations, the process 800 includes more, fewer, or different steps than shown in FIG. 8.

At step 802, the one or more processors (e.g., one or more processors of a cable modem 400-0) may receive a target loss (e.g., step 605) and a demodulation configuration of the cable modem (e.g., bit loading profile including constellation density, constellation number, or the number of bits that can carry traffic per subcarrier). In some implementations, the demodulation configuration may include a number of bits that carry traffic in the subcarrier of the plurality of subcarriers.

At step 804, the one or more processors may receive a plurality of first receive modulation error ratio (RxMER) values corresponding to a plurality of subcarriers of the cable modem (e.g., step 602).

At step 806, the one or more processors may calculate a first average loss based at least on the plurality of first RxMER values and the modulation configuration (e.g., step 604).

At step 808, for each RxMER value corresponding to a subcarrier of the plurality of subcarriers, the one or more processors may compare the first average loss with the target loss, and modify the RxMER value based on a result of the comparison (e.g., steps 615, 616, 617). In some implementations, for each RxMER value, in modifying the RxMER value, the one or more processors may be configured to determine that the first average loss is greater than the target loss and increasing the RxMER value by a first value (e.g., RxMER_Inc; see step 617). In some implementations, for each RxMER value, the one or more processors may be configured to determine that the first average loss is less than the target loss and decreasing the RxMER value by the first value (e.g., RxMER_Inc; see step 616).

At step 810, the one or more processors may set a signal-to-noise ratio (SNR) margin of the cable modem using the result of the comparison (e.g., steps 608, 609, 611, 613, 614, 618). In some implementations, in setting the SNR margin, the one or more processors may be configured to set an RxMER threshold based at least on the result of the comparison (e.g., steps 608, 609, 611, 613, 614). The one or more processors may be configured to set the SNR margin based at least on the RxMER threshold (e.g., step 618). In setting the SNR margin, the one or more processors may be further configured to subtract the RxMER threshold from an average of the plurality of first RxMER values (e.g., step 618). In setting the SNR margin, the one or more processors may be further configured to determine that the first average loss equals the target loss (e.g., step 608) and setting the RxMER threshold to an average of the plurality of first RxMER values (e.g., step 609).

In some implementations, the one or more processors may be further configured to calculate a second average loss based at least on the plurality of modified RxMER values and the modulation configuration (e.g., step 607, n>0). For each modified RxMER value corresponding to a subcarrier of the plurality of subcarriers, the one or more processors may be configured to further compare the second average loss with the target loss (e.g., step 608, n>0), and further modify the modified RxMER value based on a result of the further comparison (e.g., steps 615, 616, 617, n>0). The one or more processors may be configured to set a second RxMER threshold based at least on a result of the further comparison (e.g., steps 608, 609, 611, 613, 614, n>0). The one or more processors may be configured to set a second SNR margin of the cable modem using the second RxMER threshold (e.g., step 618, n>0).

In some implementations, in response to determining that a sign of the second average loss minus the target loss changes from a sign of the first average loss minus the target loss (e.g., step 610), the one or more processors may be further configured to determine that the second average loss is less than the target loss (e.g., steps 611) and setting the second RxMER threshold to an average of the plurality of modified RxMER values (e.g., step 613). In response to determining that a sign of the second average loss minus the target loss changes from a sign of the first average loss minus the target loss, the one or more processors may be further configured to determine that the second average loss is greater than the target loss (e.g., steps 611) and setting the second RxMER threshold to an average of the plurality of first RxMER values (e.g., step 614).

At step 812, the one or more processors may generate an alert to the system (e.g., a server 420, 590) to adjust the modulation configuration (e.g., adjusted constellation density, constellation number, or number of bits that can carry traffic) using the SNR margins. The system (e.g., a server 420, 590) may be configured to perform a modulation (e.g., QAM modulation) using the adjusted modulation configuration. In some implementations, with the system adjusting the modulation configuration, the one or more processors may be configured to monitor a change of SNR margins for a predetermined duration of time. The system (e.g., a server 420, 590) may be configured to adjust the modulation configuration using the change of SNR margins.

In some implementations, in generating the alert to the system, the one or more processors may be configured to determine the change of SNR margins falls below or exceeds a threshold value (e.g., SNR margin thresholds). The one or more processors may be configured to transmit the change (e.g., events 451) to a server, wherein the server (e.g., server 420) may include at least one of a computing device or a cloud system. The one or more processors may be configured to receive, from the server, a result of a bit loading analysis (e.g., analysis result 452). The analysis result may include one or more bit loading profiles. The one or more processors (e.g., a processor of a cable modem) may be configured to perform a demodulation using the one or more bit loading profiles.

In the following sections I to VII, the term “adjusted RxMER” and its use according to some embodiments will be described.

### I. Overview

An adjusted RxMER is a statistic based on RxMER of each data subcarrier of an OFDM channel (D3.1 and later), where the RxMER is adjusted based on the bit loading (e.g., constellation size) of the subcarrier it corresponds to.

A “mismatch” is defined between the RxMER value of a data subcarrier and the bit loading value, i.e., where the RxMER of the subcarrier could support 2 or more bits or should have 2 or fewer bits in the bit loading, in order to be close to the loss value based on the RxMER and the bit loading. 2 bits of constellation size generally corresponds to about 5.5 dB change in the RxMER threshold.

Common examples of large mismatch occur 1) with very high RxMER on a data subcarrier (much larger than threshold for the maximum constellation size); this occurs often, in practice; and 2) with a very low RxMER on a data subcarrier (even with smallest non-zero constellation size), far below (e.g., more than 3 dB below) the threshold for the constellation size. This brings up an important key factor in this invention, which employs a non-linear transformation/function of RxMER, resulting in loss, and related to loss per bit. Prior art [DOCSIS PHY specification, CM-SP-PHYv3.1, Appendix VI, Suggested Algorithm to Compute Signal-to-Noise Ratio (SNR) Margin for Candidate Profile (Informative)] relies on averaging RxMER (dB) values. Our testing and investigation have shown that there is a flaw in the averaging of RxMER (dB), even if adjusted for constellation size, without first applying a non-linear transformation on the RxMER (dB) values. To explain most simply, the averaging of RxMER (dB) without a non-linear transformation provides that a) RxMER (dB) values of extreme high value will impact the averaging, and thus the estimated SNR margin, far beyond the benefit to the link performance; and b) RxMER (dB) values of extreme low value (compared to non-zero constellation size) will impact averaging, and thus estimated SNR margin, far beyond the detriment to the link performance. In simple words, once there is “no loss” (negligible loss, or similarly, negligible probability of error) for a high SNR data subcarrier, any further increase in RxMER (dB) is not helping the link perform any better, but such higher RxMER (dB) does continue to increase the RxMER (dB) average. Similarly, once there is complete loss (loss of one bit per bit, or negligibly less than one bit per bit, or similarly, almost 50% bit error, which is as “bad” as the link can do) on a subcarrier, any further decrease in the RxMER (dB) is not hurting the link performance in further, but such lower RxMER (dB) will continue to lower the average RxMER (dB). Our invention and teaching leverages this insight just described, improving on prior art, realizing that a non-linear transformation on RxMER (dB) is required to obtain accurate SNR Margin Estimation in realistic scenarios. Further, the non-linear transformation will need to take possible infinitely positive and possibly infinitely negative RxMER (dB) values and map them into a finite range (a, b), prior to averaging, in the determination of an SNR Margin Estimate. Equivalent results and operation occur with performing a linear transformation on (a, b) to (0,1), prior to averaging, and the corresponding scaling of the target, so without loss of generality, a range for the non-linear function operating on RxMER may be (0,1) [or equivalently, [0,1]). A first embodiment had range (0.5, 1) and a second embodiment had range (0.25, 1). The range (0,1) is not limiting.. Relying on averaging RxMER (dB), or RxMER (dB) adjusted by constellation size used on the data subcarrier, as taught in prior art, is an approach with a clear drawback, and this invention solves that problem. This invention as described herein reflects adoption of a non-linear function acting on RxMER (dB), in conjunction with constellation size, and adjustments based on empirical data and analysis that are dependent on the modulation and demodulation, and forward error correction coding and decoding implementation of devices operating in the link.

When there are a significant number of data subcarriers with mismatch then the standard deviation of the RxMER can be larger than when all the data subcarriers have a good match. A system (e.g., a cable modem, a server, or any computing device) can compute a value Adjusted_RxMER_n for each data subcarrier, based on its constellation size and RxMER. This standard deviation of Adjusted_RxMER_n is important because in empirical testing for the SNR Margin Estimation in a variety of non-trivial cases, it has been noted that with a large mismatch, e.g., resulting in a relative large standard deviation of the Adjusted RxMER, (the deep narrow notch in RxMER are such cases), the SNR margin estimate may be too low and can be (safely) increased. It has been also noted that after the RxMER has been changed up or down to achieve nearly the target loss per bit value, thus the SNR margin is nearly zero dB, as computed to this point, then the measured FEC Threshold is often several tenths of a dB lower than the FEC Threshold Estimate, and up to several dB lower in some important cases observed. For this reason, the Adjusted RxMER is an important statistic to track, in order to detect cases of mismatch and make an adjustment that results in a more accurate SNR margin estimate for these cases.

### II. Definition of Adjusted RxMER

For each constellation size of a profile that is to be evaluated for its SNR margin estimate, the value of the RxMER is determined, that provides operation at FEC Threshold for Additive White Gaussian Noise (AWGN) with the same constellation size for each active subcarrier (e.g., with constant bit loading). For each constellation size b, let's denote the measured RxMER at FEC threshold, and label this value as RxMER_th_b. Then, for any value of measured RxMER on a data subcarrier (e.g., n^{th} data subcarrier), RxMER_n, with constellation size b, the Adjusted_RxMER_n is defined as:

Adjusted_RxMER_n=RxMER_n−RxMER_th_b . . . (Equation 3)

The entire vector of measured RxMER for data subcarriers in an OFDM channel is the RxMER vector; similarly, computing the Adjusted RxMER_n for each data subcarrier in the OFDM channel results in the Adjusted RxMER vector. It is noted that for constant bit loading, then RxMER_average and Adjusted_RxMER_average for the full OFDM channel can be such that (because RxMER_th_b is the same for each data subcarrier in this case):

Adjusted_RxMER_average=RxMER_average−RxMER_th_b . . . (Equation 4)

Considering a case where the values of almost all of the data subcarriers' Adjusted_RxMER_n are not too large in magnitude (e.g., less than 2.5 dB), this is not strictly AWGN, but rather has a mild variation in the RxMER vector. Then, with constant bit loading and AWGN, it is often observed that the FEC threshold occurs when Adjusted_RxMER_n equals near zero. That is not surprising in this very special case of constant bit loading, near AWGN (e.g., only mild variation of RxMER across the data subcarriers of the channel).

For cases with a significant variation in the RxMER vector across the data subcarriers, with constant bit loading, it is often the case that the FEC threshold does not occur when Adjusted_RxMER_average is near zero. In these cases, it is necessary to have the non-linear transformation, finding (or associating) a loss value for each data subcarrier (which is a function of constellation size and RxMER) which is not proportional to RxMER (in dB), and summing the entire loss values over the data subcarriers as the total loss per bit, and then finding the average loss per bit. Comparing this average loss per bit with the target loss per bit can determine if the channel can provide operation better than FEC threshold or not (which is explained in the previous sections of the present disclosure).

With constant bit loading, approaches using simply averaging of the RxMER do not provide accuracy in most interesting impairment cases other than cases with a very mild RxMER variation. In cases with a mixed modulation, where the constellation size is not always matched to the RxMER for each data subcarrier, attempting to average RxMER and using this average RxMER as a basis for SNR margin estimation may typically have significant inaccuracy. Furthermore, the inaccuracy may lead to overestimating the SNR margin, which is an undesired characteristic of an SNR margin estimate. In some implementations, the non-linear mapping of RxMER, prior to summing and averaging over the set of all data subcarriers, is preferrable in finding accurate SNR margin estimates for the impairments commonly found in cable plants.

### III. Use of Adjusted_RxMER_n

Computation of Adjusted_RxMER_n is useful in identifying cases where there is a mismatch in a non-negligible number of data subcarriers between their (a) constellation size b, and (b) RxMER. In other words, there are a non-negligible number of data subcarriers with a fairly significant absolute value of Adjusted_RxMER_n.

Statistics based upon the distribution of the vector of values, Adjusted_RxMER_n, are useful for detecting cases where a further adjustment in the SNR margin estimation result produced with the algorithm as described in present disclosure (e.g., FIG. 6) is helpful to attain close accuracy. For example, statistics such as the standard deviation of Adjusted_RxMER_n have a role in detecting cases where an adjustment in the SNR margin estimate is helpful. Large standard deviation of Adjusted_RxMER_n, such as more than 1 dB (which is an example and not limiting thereto), along with concentration of large amounts of the overall loss in a small portion of data subcarriers, such as 10 percent or 15 percent (which is an example and not limiting thereto), are indicators that the SNR margin estimate may be too low and can be (safely) increased.

### IV. Finding RxMER_th_b Given a Target Loss Per Bit

As explained in the preceding sections, in some implementations, RxMER_th_b is the RxMER value in AWGN and constant bit loading, b, which produces the FEC threshold. Alternatively, once the value for target loss per bit is found, the loss tables can equivalently be used to assign RxMER_th_b for each constellation size by finding the value of RxMER for the constellation of size b that corresponds with the target loss per bit. In this case, the loss table can have the value of loss equal to the target loss per bit times b. It is noted that the target loss per bit is the same for each constellation size in this implementation.

Some implementations allow for different “target loss per bit” values for different constellation sizes which is to be explained in the following section, along with an example and the motivation for this feature.

### V. Example of RxMER_th_b Values in AWGN, Determined in Empirical Testing

The following values of RxMER_th_b were measured for a cable modem and downstream modulator operating together in AWGN and constant bit loading:
8-bit, 256-QAM: RxMER_th_b in AWGN=24.35 dB;
9-bit, 512-QAM: RxMER_th_b in AWGN=27.04 dB;
10-bit, 1K-QAM: RxMER_th_b in AWGN=29.87 dB;
11-bit, 2K-QAM: RxMER_th_b in AWGN=32.60 dB;
12-bit, 4K-QAM: RxMER_th_b in AWGN=35.58 dB.

### VI. Accommodating Constellation(s) With Different “Target Loss Per Bit” Than Other Constellations

There is an embodiment where a different “target loss per bit” is used for different constellation sizes. This is handled by modifying the loss given by (a) an RxMER and (b) one of the different constellation sizes (e.g., one of the constellation sizes that have a target loss per bit different from the general target loss per bit).

The loss for the constellation with a different “target loss per bit” is modified as below:
Constellation size with a different “target loss per bit” is denoted by b;
Constellation size b has a “target loss per bit” denoted by “TLPB”;
General target loss per bit is denoted by “GTLPB”;

Difference=GTLPB−TLPB . . . (Equation 5);
Constellation size b with given RxMER has “loss” L (which can be obtained from the loss tables);
Constellation size b with given RxMER has the calculated “loss_modified” denoted by “LM”;

LM=L+[(GTLPB−TLPB)*b] . . . (Equation 6);

In some implementations, the value of LM is used in summing the loss over all the data subcarriers, instead of L, in the algorithm for computing the SNR margin estimate (e.g., FIG. 6), during the calculation of the average loss per bit over the entire set of subcarriers.

For example, suppose that constellation size b with a different “target loss per bit” equals 12. Constellation size b has a “target loss per bit” (TLPB) equal to 0.042 and “general target loss per bit” (GTLPB) equal to 0.062. The difference according to Equation 5 is calculated as follows: Difference=GTLPB−TLPB=0.062−0.042=0.02. Constellation size b with given RxMER has “loss” L equal to 0.6 (which can be obtained from the loss tables). Constellation size b with given RxMER has the calculated “loss_modified” LM equal to 0.84 using Equation 6 as follows:

LM=L+[(GTLPB−TLPB)*b]=L+Difference*b=0.6+0.02*12=0.6+0.24=0.84

### VII. History and Application

Empirical testing with a cable modem and a downstream modulator indicated that the “target loss per bit” for the largest constellation size (12-bits, 4K-QAM) they supported needed to be lower in AWGN and constant bit loading, than the “target loss per bit” for all smaller constellations. The difference was small, but resulted in a few tenths of error in the SNR margin estimate for the 12-bit constellation. The actual margin was measured to be a little lower than the estimated margin using the “target loss per bit” of the smaller constellations. The application of the modification in this section corrected the error in the SNR margin estimates for the AWGN and constant bit loading with 12-bits, and also corrected the SNR margin estimates for mixed modulations using the 12-bit loading for some data subcarriers. There was additional implementation loss in those particular devices when operating at the highest constellation size. This modification in calculating the total loss over the full set of subcarriers by adjusting the “loss” found from the table for b equal 12, mitigated the estimation error.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

It should be noted that certain passages of this disclosure can reference terms such as “first” and “second” in connection with subsets of transmit spatial streams, sounding frames, response, and devices, for purposes of identifying or differentiating one from another or from others. These terms are not intended to merely relate entities (e.g., a first device and a second device) temporally or according to a sequence, although in some cases, these entities can include such a relationship. Nor do these terms limit the number of possible entities (e.g., STAs, APs, beamformers and/or beamformees) that can operate within a system or environment. It should be understood that the systems described above can provide multiple ones of any or each of those components and these components can be provided on either a standalone machine or, In some implementations, on multiple machines in a distributed system. Further still, bit field positions can be changed and multibit words can be used. In addition, the systems and methods described above can be provided as one or more computer-readable programs or executable instructions embodied on or in one or more articles of manufacture, e.g., a floppy disk, a hard disk, a CD-ROM, a flash memory card, a PROM, a RAM, a ROM, or a magnetic tape. The programs can be implemented in any programming language, such as LISP, PERL, C, C++, C#, or in any byte code language such as JAVA. The software programs or executable instructions can be stored on or in one or more articles of manufacture as object code.

While the foregoing written description of the methods and systems enables one of ordinary skill to make and use embodiments thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A cable modem, comprising one or more processors configured to:
receive a target loss and a modulation configuration of the cable modem;
receive a plurality of first receive modulation error ratio (RxMER) values corresponding to a plurality of subcarriers of the cable modem;
calculate a first average loss based at least on the plurality of first RxMER values and the modulation configuration;
for each RxMER value corresponding to a subcarrier of the plurality of subcarriers, compare the first average loss with the target loss, and modify the RxMER value based on a result of the comparison; and
set a signal-to-noise ratio (SNR) margin of the cable modem using the result of the comparison.

2. The cable modem of claim 1, wherein the modulation configuration includes a number of bits that can carry traffic in the subcarrier of the plurality of subcarriers.

3. The cable modem of claim 1, wherein for each RxMER value, in modifying the RxMER value, the one or more processors are configured to:
determine that the first average loss is greater than the target loss and increasing the RxMER value by a first value; or
determine that the first average loss is less than the target loss and decreasing the RxMER value by the first value.

4. The cable modem of claim 1, wherein in setting the SNR margin, the one or more processors are configured to:
set an RxMER threshold based at least on the result of the comparison; and
set the SNR margin based at least on the RxMER threshold.

5. The cable modem of claim 4, wherein in setting the SNR margin, the one or more processors are further configured to:
subtract the RxMER threshold from an average of the plurality of first RxMER values.

6. The cable modem of claim 4, wherein in setting the SNR margin, the one or more processors are further configured to:
determine that the first average loss equals the target loss and setting the RxMER threshold to an average of the plurality of first RxMER values.

7. The cable modem of claim 1, wherein the one or more processors are further configured to:
calculate a second average loss based at least on the plurality of modified RxMER values and the modulation configuration;
for each modified RxMER value corresponding to a subcarrier of the plurality of subcarriers, further compare the second average loss with the target loss, and further adjust the modified RxMER value based on a result of the further comparison;
set a second RxMER threshold based at least on a result of the further comparison; and
set a second SNR margin of the cable modem using the second RxMER threshold.

8. The cable modem of claim 7, wherein the one or more processors are further configured to:
in response to determining that a sign of the second average loss minus the target loss changes from a sign of the first average loss minus the target loss:
determine that the second average loss is less than the target loss and setting the second RxMER threshold to an average of the plurality of modified RxMER values; or
determine that the second average loss is greater than the target loss and setting the second RxMER threshold to an average of the plurality of first RxMER values.

9. A method for identifying signal-to-noise ratio (SNR) margins, comprising:
receiving, by one or more processors of a cable modem, a target loss and a modulation configuration of the cable modem;
receiving, by the one or more processors, a plurality of first receive modulation error ratio (RxMER) values corresponding to a plurality of subcarriers of the cable modem;
calculating, by the one or more processors, a first average loss based at least on the plurality of first RxMER values and the modulation configuration;
for each RxMER value corresponding to a subcarrier of the plurality of subcarriers, comparing the first average loss with the target loss, and modifying the RxMER value based on a result of the comparison; and
setting, by the one or more processors, an SNR margin of the cable modem using the result of the comparison.

10. The method of claim 9, wherein the modulation configuration includes a number of bits that can carry traffic in the subcarrier of the plurality of subcarriers.

11. The method of claim 9, wherein for each RxMER value, modifying the RxMER value comprises:
determining that the first average loss is greater than the target loss and increasing the RxMER value by a first value; or
determining that the first average loss is less than the target loss and decreasing the RxMER value by the first value.

12. The method of claim 9, wherein setting the SNR margin comprises:
setting an RxMER threshold based at least on the result of the comparison; and
setting the SNR margin based at least on the RxMER threshold.

13. The method of claim 12, wherein setting the SNR margin further comprises:
subtracting the RxMER threshold from an average of the plurality of first RxMER values.

14. The method of claim 12, wherein setting the SNR margin further comprises:
determining that the first average loss equals the target loss and setting the RxMER threshold to an average of the plurality of first RxMER values.

15. The method of claim 9, further comprising:
calculating a second average loss based at least on the plurality of modified RxMER values and the modulation configuration;
for each modified RxMER value corresponding to a subcarrier of the plurality of subcarriers, further comparing the second average loss with the target loss, and further adjusting the modified RxMER value based on a result of the further comparison;
setting a second RxMER threshold based at least on a result of the further comparison; and
setting a second SNR margin of the cable modem using the second RxMER threshold.

16. The method of claim 15, further comprising:
in response to determining that a sign of the second average loss minus the target loss changes from a sign of the first average loss minus the target loss:
determining that the second average loss is less than the target loss and setting the second RxMER threshold to an average of the plurality of modified RxMER values; or
determining that the second average loss is greater than the target loss and setting the second RxMER threshold to an average of the plurality of first RxMER values.

17. A system for monitoring signal-to-noise ratio (SNR) margins of one or more cable modems, comprising:
a cable modem comprising one or more processors; and
a server comprising at least one of a computing device or a cloud system, wherein
the one or more processors of the cable modem is configured to:
receive a plurality of receive modulation error ratio (RxMER) values corresponding to a plurality of subcarriers of the cable modem;
receive a plurality of profiles, each profile comprising a plurality of modulation configurations corresponding to the plurality of subcarriers of the cable modem, the plurality of profiles including a first profile with which the cable modem performs a demodulation;
for each of the plurality of profiles, calculate an SNR margin of the cable modem based at least on the plurality of RxMER values and the profile;
compare the SNR margin for the first profile with a threshold; and
determine that the SNR margin for the first profile falls below or exceeds the threshold, and transmit a notification to the server.

18. The system of claim 17, wherein
the server is configured to:
determine, based at least on the notification, a second profile among the plurality of profiles, wherein the notification comprises a result of the comparison and the plurality of SNR margins calculated for the plurality of profiles; and
transmit, to the cable modem, an indication of the second profile, and
in response to receiving the indication of the second profile, the cable modem is configured to perform a demodulation using the second profile.

19. The system of claim 18, wherein
the threshold is a first threshold or a second threshold greater than the first threshold, and
in determining the second profile, the server is configured to:
in response to determining the SNR margin for the first profile falls below the first threshold, determine the second profile that incurs less decoding errors than the first profile; and
in response to determining the SNR margin for the first profile exceeds the second threshold, determine the second profile that achieves higher throughput than the first profile.

20. The system of claim 19, wherein
each of the plurality of profiles includes a plurality of constellation sizes corresponding to the plurality of subcarriers, and
in determining the second profile, the server is configured to:
in response to determining the SNR margin for the first profile falls below the first threshold, determine the second profile that comprises a constellation size less than a constellation size of the first profile; and
in response to determining the SNR margin for the first profile exceeds the second threshold, determine the second profile that comprises a constellation size greater than a constellation size of the first profile.
